(19) United States
(12) Patent Application Publication
(10) Pub. No.: US 2025/0254725 A1
(43) Pub. Date: Aug. 7, 2025

(54) NON-PRIMARY CHANNEL ACCESS SWITCHING CONDITIONS

(71) Applicant: QUALCOMM Incorporated, San Diego, CA (US)

(72) Inventors: Gaurang NAIK, San Diego, CA (US); George CHERIAN, San Diego, CA (US); Alfred ASTERJADHI, San Diego, CA (US); Abhishek Pramod PATIL, San Diego, CA (US); Sai Yiu Duncan HO, San Diego, CA (US); Youhan KIM, Saratoga, CA (US); Sherief HELWA, San Diego, CA (US); Giovanni CHISCI, San Diego, CA (US); Sanket Sanjay KALAMKAR, San Diego, CA (US)

(21) Appl. No.: 19/035,641

(22) Filed: Jan. 23, 2025

Related U.S. Application Data
(60) Provisional application No. 63/550,997, filed on Feb. 7, 2024.

(51) Int. Cl. H04W 74/0816; H04W 74/00; H04W 74/08

(52) U.S. Cl. CPC H04W 74/0816; H04W 74/002; H04W 74/0866

(57) ABSTRACT

This disclosure provides methods, components, devices and systems for non-primary channel access switching conditions. Some aspects more specifically relate to first wireless communication device may receive an indication of a frame initiating a transmission opportunity associated with an upcoming data transmission on a first primary channel. In some examples, the first wireless communication device may switch to a second primary channel based on determining that a threshold duration has elapsed from an end of the frame initiating the transmission opportunity. In some examples, the first wireless communication device may receive an indication of a physical layer protocol data unit (PPDU) associated with an upcoming data transmission on the first primary channel. In some examples, the first wireless communication device may switch to a second primary channel based on a length of the PPDU satisfying a threshold value and on the PPDU being an inter-basic service set (inter-BSS) PPDU.

### CROSS REFERENCE

The present Application for Patent claims priority to U.S. Provisional Patent Application No. 63/550,997 by NAIK et al., entitled “NON-PRIMARY CHANNEL ACCESS SWITCHING CONDITIONS,” filed Feb. 7, 2024, assigned to the assignee hereof, and expressly incorporated by reference in its entirety herein.

### TECHNICAL FIELD

This disclosure relates generally to wireless communication and, more specifically, to non-primary channel access (NPCA) switching conditions.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

In some WLAN, a wireless communication device may communicate via subchannels over a frequency range. For instance, the subchannels may together support a bandwidth of up to 320 MHz. In some cases, one subchannel may be designated as a primary channel. For instance, the wireless communication device may contend for access via the primary channel. In some cases, access to a wider bandwidth (such as wider than the primary channel) may be contingent on access to the primary channel. Additionally, the primary channel may be occupied by, as an example, an overlapping basic service set (OBSS) transmission. In examples in which the primary channel is occupied by the OBSS, however, a remainder of the bandwidth may be unutilized as wireless communication devices may not successfully contend for the primary channel and not be able to utilize the remainder of the bandwidth.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a first wireless communication device. The method may include receiving, from a second wireless communications device and on a first primary channel, an indication of a frame initiating a transmission opportunity associated with an upcoming data transmission on the first primary channel, switching to a second primary channel based on determining that a threshold duration has elapsed from an end of the frame initiating the transmission opportunity, and communicating on the second primary channel based on switching to the second primary channel.

Another innovative aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to receive, from a second wireless communications device and on a first primary channel, an indication of a frame initiating a transmission opportunity associated with an upcoming data transmission on the first primary channel, switch to a second primary channel based on determining that a threshold duration has elapsed from an end of the frame initiating the transmission opportunity, and communicate on the second primary channel based on switching to the second primary channel.

Another innovative aspect of the subject matter described in this disclosure can be implemented in a first wireless communication device for wireless communication. The first wireless communication device may include means for receiving, from a second wireless communications device and on a first primary channel, an indication of a frame initiating a transmission opportunity associated with an upcoming data transmission on the first primary channel, means for switching to a second primary channel based on determining that a threshold duration has elapsed from an end of the frame initiating the transmission opportunity, and means for communicating on the second primary channel based on switching to the second primary channel.

Another innovative aspect of the subject matter described in this disclosure can be implemented in a non-transitory computer-readable medium storing code for wireless communication. The code may include instructions executable by one or more processors to receive, from a second wireless communications device and on a first primary channel, an indication of a frame initiating a transmission opportunity associated with an upcoming data transmission on the first primary channel, switch to a second primary channel based on determining that a threshold duration has elapsed from an end of the frame initiating the transmission opportunity, and communicate on the second primary channel based on switching to the second primary channel.

In some examples of the method, processing system, and non-transitory computer-readable medium described herein, receiving the indication may include operations, features, means, or instructions for receiving, from the second wireless communications device and on the first primary channel, the indication of a short initial control frame including a duration of upcoming data transmission on the first primary channel, where the duration of upcoming data transmission on the first primary channel satisfies a threshold duration value.

Some examples of the method, processing system, and non-transitory computer-readable medium described herein may further include operations, features, means, or instructions for switching to the first primary channel before expiration of the duration of upcoming data transmission on the first primary channel.

In some examples, the threshold duration includes a sum of an initial control frame time value, a receiver start delay time value, and two times a short interframe space time value.

Another innovative aspect of the subject matter described in this disclosure can be implemented in a method for wireless communication by a first wireless communication device. The method may include receiving, from a second wireless communications device and on a first primary channel, an indication of a physical layer protocol data unit (PPDU) associated with an upcoming data transmission on the first primary channel, the PPDU including a header portion and a data portion, switching to a second primary channel based on a length of the PPDU satisfying a threshold value and on the PPDU being an inter-basic service set (inter-BSS) PPDU, and communicating on the second primary channel based on switching to the second primary channel.

Another innovative aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to receive, from a second wireless communications device and on a first primary channel, an indication of a physical layer PPDU associated with an upcoming data transmission on the first primary channel, the PPDU including a header portion and a data portion, switch to a second primary channel based on a length of the PPDU satisfying a threshold value and on the PPDU being an inter-BSS PPDU, and communicate on the second primary channel based on switching to the second primary channel.

Another innovative aspect of the subject matter described in this disclosure can be implemented in a first wireless communication device for wireless communication. The first wireless communication device may include means for receiving, from a second wireless communications device and on a first primary channel, an indication of a physical layer PPDU associated with an upcoming data transmission on the first primary channel, the PPDU including a header portion and a data portion, means for switching to a second primary channel based on a length of the PPDU satisfying a threshold value and on the PPDU being an inter-BSS PPDU, and means for communicating on the second primary channel based on switching to the second primary channel.

Another innovative aspect of the subject matter described in this disclosure can be implemented in a non-transitory computer-readable medium storing code for wireless communication. The code may include instructions executable by one or more processors to receive, from a second wireless communications device and on a first primary channel, an indication of a physical layer PPDU associated with an upcoming data transmission on the first primary channel, the PPDU including a header portion and a data portion, switch to a second primary channel based on a length of the PPDU satisfying a threshold value and on the PPDU being an inter-BSS PPDU, and communicate on the second primary channel based on switching to the second primary channel.

Some examples of the method, processing system, and non-transitory computer-readable medium described herein may further include operations, features, means, or instructions for decoding a first field included in the header portion of the PPDU to identify the length of the PPDU and decoding a second field included in the header portion of the PPDU to identify that the PPDU may be the inter-BSS PPDU, where the first field may be located earlier than the second field in the header portion.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a wireless communications system that supports non-primary channel access (NPCA) switching conditions.

FIG. 6 shows an example of wireless communications that support NPCA switching conditions.

FIG. 7 shows an example of wireless communications that support NPCA switching conditions.

FIG. 8 shows an example of PPDUs that support NPCA switching conditions.

FIGS. 9 and 10 show block diagrams of devices that support NPCA switching conditions in accordance with one or more aspects of the present disclosure.

FIG. 11 shows a block diagram of an example wireless communication device that supports NPCA switching conditions.

FIG. 12 shows a diagram of a system including a device that supports NPCA switching conditions in accordance with one or more aspects of the present disclosure.

FIGS. 13 through 16 show flowcharts illustrating example processes performable by or at a STA that supports NPCA switching conditions.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Various aspects relate generally to wireless communication and more particularly to channel access. Some aspects more specifically relate to conditions under which a wireless communication device may consider switching to a second primary channel after determining that a first primary channel is unavailable, as well as procedures related to accessing the second primary channel in examples in which the second primary channel is accessible. In some examples, a first wireless communication device, such as a non-primary channel access (NPCA) capable station (STA), may receive, on a first primary channel, an indication of a frame initiating a transmission opportunity associated with an upcoming data transmission on the first primary channel. The first primary channel in this example may be a main primary channel (such as M-Primary channel). After determining that the first primary channel is scheduled to be busy (such as due to the upcoming data transmission), the NPCA-capable STA may determine to switch to a second primary channel based on a threshold duration elapsing from an end of the frame initiating the transmission opportunity. In some examples, the second primary channel may be an opportunistic primary channel (such as O-Primary channel). The frame received by the NPCA-capable STA may be or may include a short initial control frame (ICF) or an initial control response (ICR) frame. The NPCA-capable STA may switch to the second primary channel after determining that a threshold duration has elapsed since the end of the frame including the ICF and/or ICR. As such, the NPCA-capable STA may then communicate on the second primary channel.

In some examples, one or more STAs and access point (APs) may be configured to communicate without using ICF or ICR. In such cases, a wireless communication device may initiate a transmission opportunity using a physical layer (PHY) protocol data unit (PPDU). The NPCA-capable STA may receive an indication of the PPDU associated with an upcoming data transmission on the first primary channel, the PPDU including a header portion and a data portion. To perform a switch to the second primary channel, the NPCA-capable STA may determine a duration, such as a maximum duration, for which frame exchanges are permitted on the second primary channel and a time for switching to the second primary channel. For example, the NPCA-capable STA may decode a first field included in the header portion of the PPDU to identify a length of the PPDU. The NPCA-capable STA may then decode a second field included in the header portion of the PPDU to identify whether the PPDU is an inter-BSS PPDU. Based on the length of the PPDU and identifying that the PPDU is an inter-BSS PPDU, the NPCA-capable STA may switch to the second primary channel. The NPCA-capable STA may then communicate on the second primary channel.

Particular aspects of the subject matter described in this disclosure can be implemented to realize one or more of the following potential advantages. By determining the conditions under which the NPCA-capable STA may switch to the second primary channel, a wireless communication device, such as a STA, may improve performance of the second primary channel. For example, a transmitter and a receiver may align on the timing for switching to and communicating on the second primary channel, thereby reducing mismatch and increasing communication performance, among other advantages. In particular, operating in accordance with the subject matter in this disclosure may increase a probability that the NPCA-capable STA may switch to the second primary channel in coordination with (such as at a same time as) a receiver, thereby reducing contention on the second primary channel and increasing the probability of successful transmissions, among other advantages.

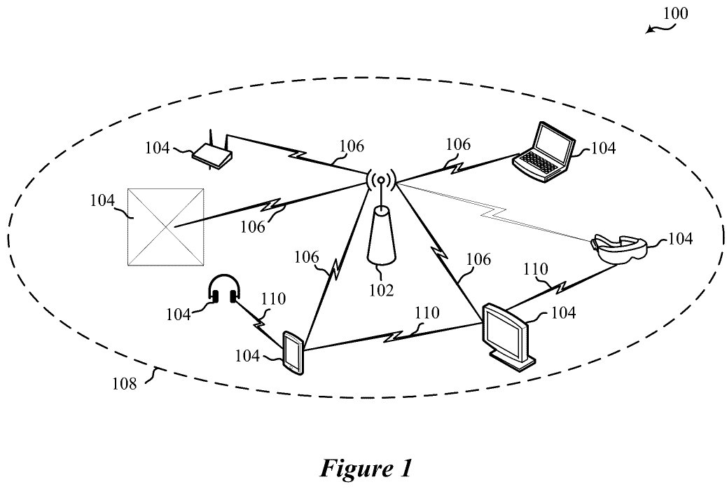

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless AP 102 and any quantity of wireless STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IOT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (such as wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (such as “legacy preamble”) and a non-legacy portion (such as “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (for example, High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (such as “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QOS) parameters. For example, existing technology (such as IEEE 802.11ax standard amendment protocols) supports the use of up to 1024-QAM, where a modulated symbol carries 10 bits. To further improve peak data rate, each of the AP 102 or the STA 104 may employ use of 4096-QAM (also referred to as “4 k QAM”), which enables a modulated symbol to carry 12 bits. 4 k QAM may enable massive peak throughput with a maximum theoretical PHY rate of 10bps/Hz/subcarrier/spatial stream, which translates to 23 Gbps with 5/6 LDPC code (10 bps/Hz/subcarrier/spatial stream*996*4 subcarriers*8 spatial streams/13.6 μs per OFDM symbol). The AP 102 or the STA 104 using 4096-QAM may enable a 20% increase in data rate compared to 1024-QAM given the same coding rate, thereby allowing users to obtain higher transmission efficiency.

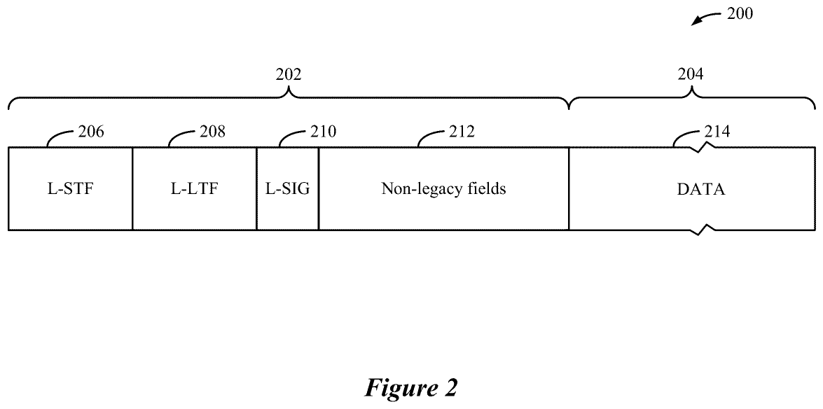

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

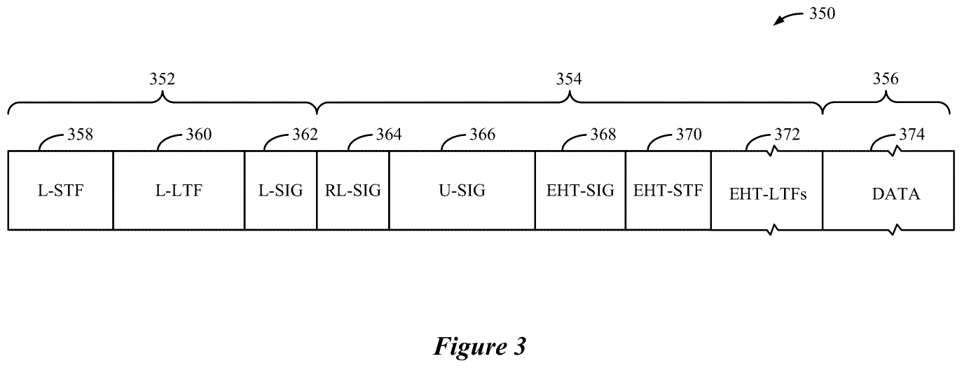

FIG. 3 shows an example PHY PPDU 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT-or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as an AP 102 or a STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the quantity of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

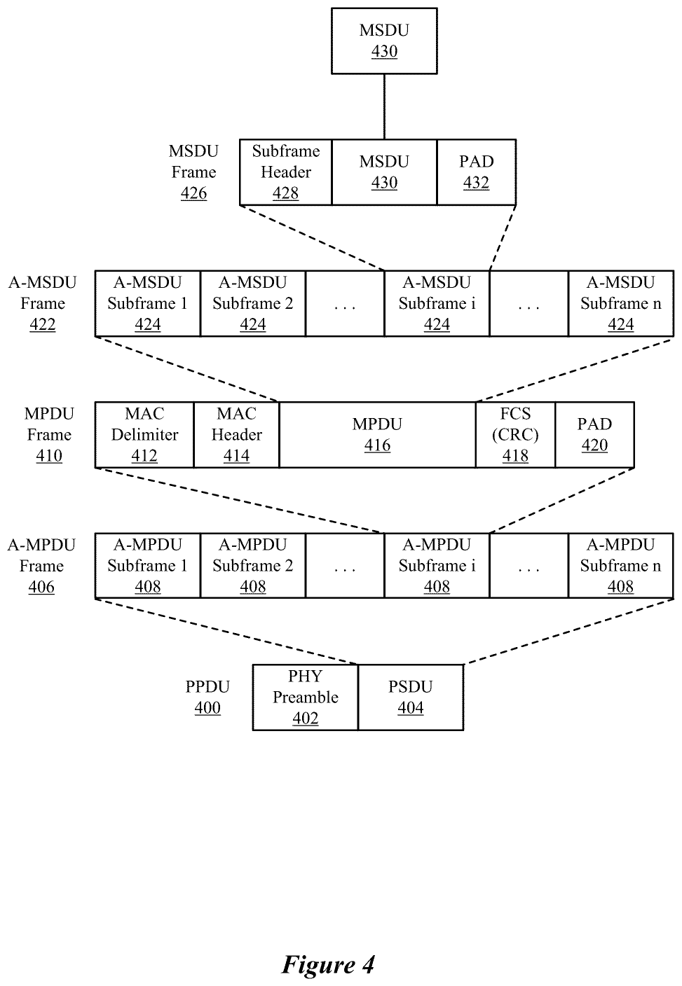

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (such as “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (such as “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a NAV, which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (such as “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Retransmission protocols, such as hybrid automatic repeat request (HARQ), also may offer performance gains. A HARQ protocol may support various HARQ signaling between transmitting and receiving wireless communication devices (for example, the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example, a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

APs and STAs (for example, the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (such as “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (such as rRU) refers to any RU or MRU tone plan that is not distributed, such as a configuration supported by 802.11be or earlier versions of the IEEE 802.11 family of wireless communication protocol standards. As used herein, the term “distributed RU” (such as dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

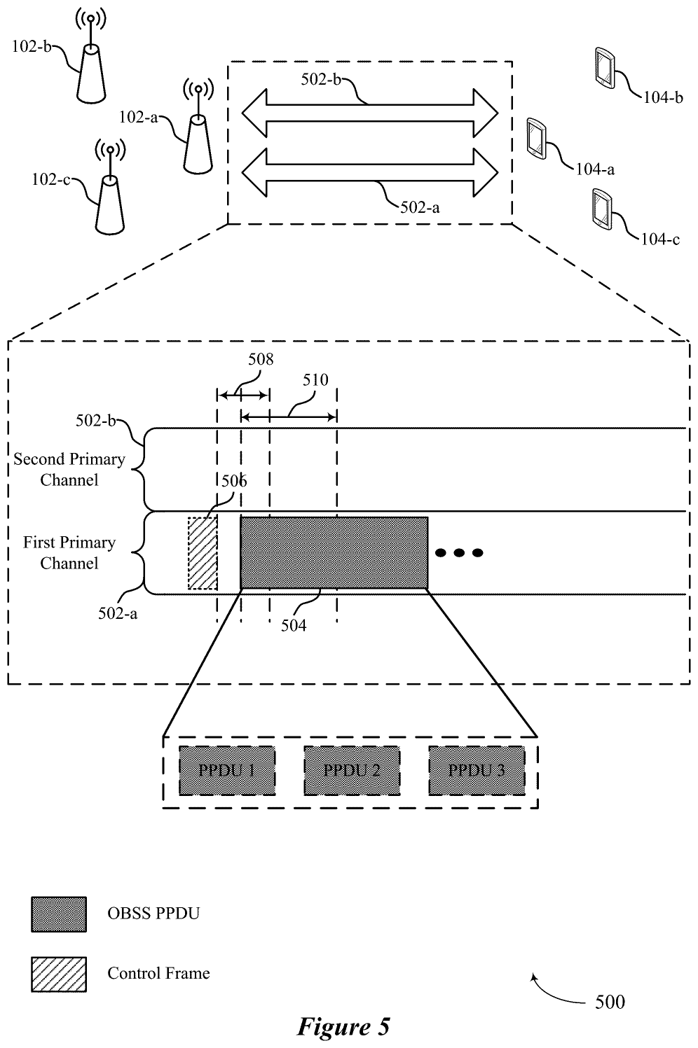

FIG. 5 shows a wireless communication system 500 depicting an example distributed tone mapping. The wireless communication system 500 may implement or be implemented to realize one or more aspects of the wireless communication network 100, the PDU 200, the PPDU 350, or any combination thereof. For example, the wireless communication system 500 illustrates communication between an AP 102-a, an AP 102-b, an AP 102-c and a STA 104-a, a STA 104-b, and a STA 104-c on a first primary channel 502-a (main primary channel (M-Primary channel)) and a second primary channel 502-b (opportunistic primary channel (O-Primary channel)), which may be examples of the AP 102 and the STA 104 respectively, as illustrated by and described with reference to FIG. 1.

The APs 102 may communicate with associated STAs 104 over one or more channels. For example, the AP 102-a and the STA 104-a may communicate on the first primary channel 502-a. In some aspects, the first primary channel 502-a may be associated with a frequency range or bandwidth, such as 20 MHz. The first primary channel 502-a may be referred to as a primary channel (such as M-Primary), and/or primary-1. In some examples, the APs 102 and the STAs 104 may communicate on the second primary channel 502-b. In some aspects, the second primary channel 502-b may be associated with a frequency range or bandwidth, such as 20 MHz. The frequency range and/or bandwidth associated with the second primary channel 502-b may be the same as or different than the frequency range or bandwidth associated with the first primary channel 502-a. The second primary channel 502-b may be referred to as an opportunistic channel (such as an O-Primary channel), an anchor channel, an auxiliary channel, temporary primary channel, a temporary channel, NPCA primary channel, and/or primary-2. The second primary channel 502-b may be a back-up or fallback channel to the first primary channel 502-a. Additionally, or alternatively, the APs 102 may perform enhanced multi-link single-radio (EMLSR) operations. For example, the AP 102, which may be an example of an EMLSR AP, may communicate via a primary link and nonprimary links. In some aspects, the first primary channel 502-a and the second primary channel 502-b may be on different communication links. The first primary channel 502-a may be on the first primary channel 502-a while the second primary channel 502-b may be on one of the nonprimary links (such as in an EMLSR operation). Alternatively, the first primary channel 502-a and the second primary channel 502-b may be on a same communication link (such as in a NPCA operation). The APs 102 and the STAs 104 may communicate on the second primary channel 502-b in examples in which the first primary channel 502-a is unavailable (such as busy).

As depicted herein, Wi-Fi offers support for very large bandwidths. For example, some wireless communications systems may support bandwidth for up to 320 MHz. Within the large bandwidth, a 20 MHz channel may be designated as a primary channel. A Wi-Fi device (AP or STA) may contend for access only on the primary channel. Access to wide bandwidths (no matter how large) is contingent on access to the primary channel. Therefore, if an overlapping basic service set (OBSS) STA occupies the primary channel, remainder of the wide bandwidth may remain unutilized, which may contribute to lower-throughput and longer latencies. In some examples, a UHR device may be capable of monitoring additional 20 MHz primary channel(s) within the operating bandwidth. As depicted herein, the baseline primary channel is referred to as an M-Primary channel. The additional primary channel is referred to as an O-Primary channel. In some examples, monitoring of the O-Primary channels can be sequential or parallel. Sequential monitoring may be suitable for devices that have one radio (such as STA 104 having a single radio). When OBSS is detected on primary channel, a STA may switch its radio to O-Primary channel and may contend for the channel.

A STA that supports sequential monitoring may be referred to as Type-2 device. In addition to the main radio, the STA may have an additional hardware to monitor the O-Primary channels. The additional hardware capability may be or include another full radio, an AUX radio capable of detecting preambles and decoding non-HT PPDUs (also referred to as Type-0 device), a STF detector capable of detecting the L-STF of PPDUs but not capable of decoding PPDUs (such as L-SIG) (also referred to as Type-1 device), energy detector capable of measuring energy but may not include detection or decode capabilities (also referred to as Type-2+ device).

In some examples, a STA (such as NPCA-capable STA) may be capable of switching from a primary channel to a non-primary channel. In some examples, the NPCA-capable STA may determine that the M-Primary channel is occupied by another transmission (such as another transmission from another STA or an AP). In such cases, the NPCA-capable STA may decide to switch from M-Primary channel to O-Primary channel. For instance, to switch from M-Primary channel to O-Primary channel, the NPCA-capable STA may use some critical information. Such information may include an indication of whether a PPDU occupying the M-Primary channel is OBSS (such as an inter-BSS PPDU) or in-BSS (such as an intra-BSS PPDU). In some examples, the NPCA-capable STA can switch to O-Primary channel only if the PPDU occupying the M-Primary channel is an OBSS PPDU. Additionally, or alternatively, the information may include a maximum duration for which the NPCA-capable STA can remain and perform frame exchanges with a peer NPCA-capable STA on the O-Primary channel. And optionally, the information may include whether this duration is sufficient to exchange frames with the peer STA on the O-Primary channel.

After acquiring such information, the NPCA-capable STA can switch to the O-Primary channel. The NPCA-capable STA may determine to switch back to the M-Primary channel by the time the maximum duration has elapsed. To facilitate smooth NPCA operation, both peer NPCA-capable STAs may operate in accordance with a common understanding of when to switch to the O-Primary channel and when to switch back to the M-Primary channel. Otherwise, there may be a loss in coordination between the peer STAs. For example, an AP may switch to the O-Primary channel and may send an ICF (such as an RTS, MU-RTS Trigger frame or a BSRP Trigger frame) to check whether a STA has switched. However, the STA may not be able to respond because it may not have switched to the O-Primary channel at the time when the AP sends the ICF. This may lead to the AP concluding that the STA did not receive the OBSS PPDUs and may result in a loss of coordination. Additionally, or alternatively, if the maximum duration inferred by the AP and STA are different, then one peer may initiate switch back to the M-Primary channel sooner than the other, thereby causing potential dropping of PPDUs and loss in NPCA performance.

One or more aspects of the present disclosure provide for identifying a time for switching to the O-Primary channel and the maximum duration for communicating on the O-Primary channel. In some examples, the time for switching to the O-Primary channel and the maximum duration for communicating on the O-Primary channel may depend on a type of OBSS frame exchange and a transmission opportunity protection strategy used by OBSS transmission opportunity holder. Depending on these factors, the NPCA-capable STA and the AP may communicate in accordance with two cases. In a first case, the transmission opportunity may be initiated with a short ICF on the M-Primary channel. In general, this frame may not be a control frame. As depicted herein, the term ICF may refer to any short frame (Data/Control/Management frame) that initiates the transmission opportunity. In a second case, there may not be a short ICF used to initiate a transmission opportunity. Additionally, or alternatively, the NPCA-capable STA may receive an ICF, but may not identify sufficient transmission opportunity protection from the ICF. In such cases, the NPCA-capable STA may switch to the O-Primary channel in accordance with one or more techniques depicted herein.

According to one or more aspects, the STA 104-a (NPCA-capable STA) may contend for access to the first primary channel 502-a. While contending for access, the STA 104-a may detect (such as identify) an OBSS PPDU 504 on the first primary channel 502-a. Optionally, the OBSS PPDU 504 may be divided into smaller PPDUs (such as PPDU1, PPDU2, and PPDU3). That is, the STA 104-a may determine that the first primary channel 502-a is occupied by the OBSS PPDU 504. In accordance with the first case, the STA 104-a may identify an ICF frame initiating a transmission opportunity on the first primary channel 502-a. For example, one or more of the STAs 104, such as the STA 104-b may occupy the first primary channel 502-a with the OBSS PPDU 504 such that the AP 102-a, the AP 102-b, the AP 102-c, the STA 104-a , and/or the STA 104-c may detect the OBSS PPDU 504.

After detecting the OBSS PPDU 504, the STA 104-a may switch to the second primary channel 502-b. For example, the STA 104-a may switch to a second primary channel based on determining that a threshold duration has elapsed from an end of the frame 506 initiating the transmission opportunity. In some aspects, the STA 104-a may switch to the second primary channel 502-b after the time duration 508 that has elapsed from the frame 506. The frame 506 may be an ICF or an ICR. Additionally, or alternatively, if the STA 104-a fails to receive the ICF, or if the ICF is not included in the transmission, then the STA 104-a may switch to the second primary channel 502-b based on a length of the PPDU satisfying a threshold value and on the PPDU being an inter-BSS PPDU. In this example, the STA 104-a may switch to the second primary channel 502-b after threshold time 510.

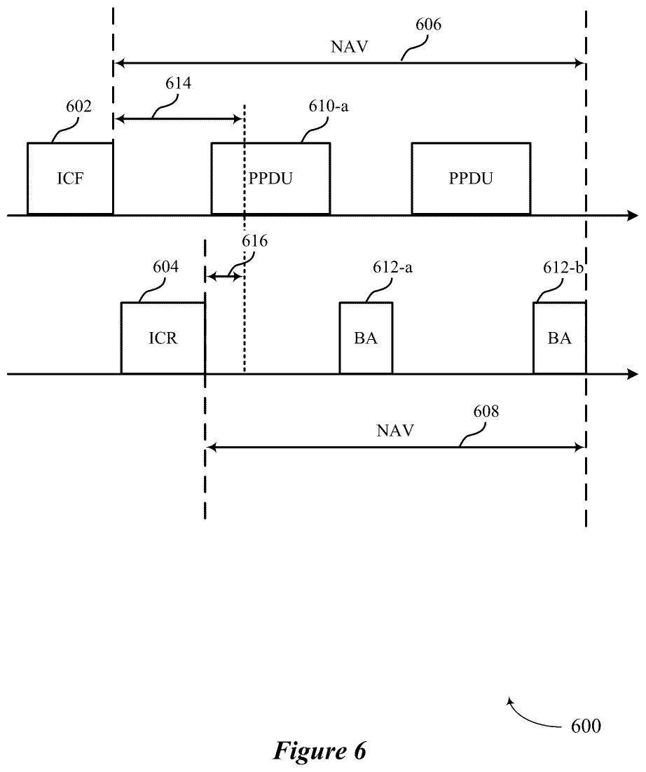

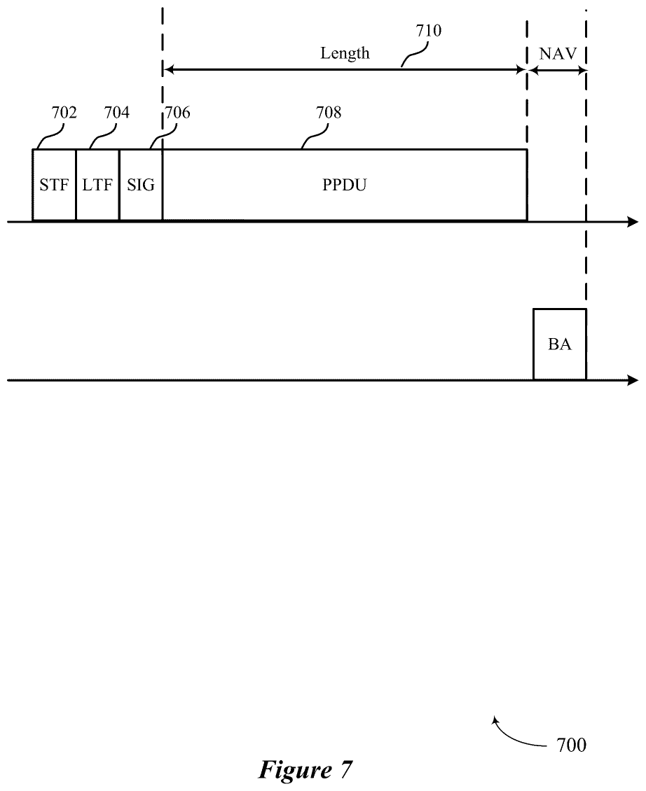

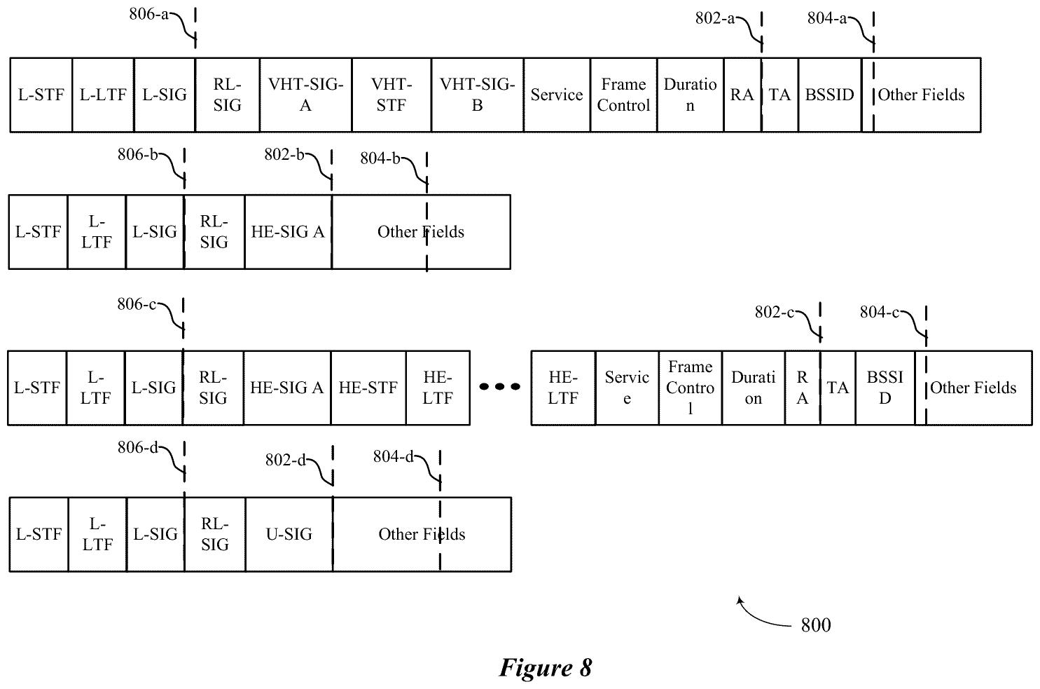

The STA 104-a may support switching to the second primary channel 502-b in accordance with rules associated with the first case (where ICF or ICR is detected) or in accordance with rules associated with the second case (where ICF or ICR is not used to initiate a transmission opportunity). The APs 102 may indicate whether the STAs are allowed to switch to the second primary channel 502-b in accordance with the first case, the second case, or both. As an example, an AP 102 may transmit an indication (such as in a beacon) that the STAs are allowed to switch to the second primary channel 502-b in accordance with the first case but not the second case (or vice versa). The first case is described in further detail with reference to FIG. 6 and the second case is described in further detail with reference to FIGS. 7 and 8.

In some examples, switching to the second primary channel 502-b (such as NPCA behavior) may be allowed in the first case (where ICF or ICR is detected). That is, the STAs may be configured to (such as receive an indication from an AP to, including by receiving one or more beacons) switch to the O-Primary channel if the OBSS transmission opportunity is initiated with an ICF or ICR exchange and a duration of upcoming data transmission on the first primary channel (such as NAV) is greater than a threshold (such as NPCA_NAV_Threshold). Otherwise, the STA may not be configured to switch to the O-Primary channel (such as second primary channel 502-b). In cases where the NPCA-capable STAs are allowed to switch to the O-Primary channel, the NPCA-capable STAs may switch back to the M-Primary prior before the NAV expires. This may include any switching delays incurred by the AP or the STA.

Additionally, or alternatively, switching to the second primary channel 502-b (such as NPCA behavior) may be allowed in the second case (where ICF or ICR is not used to initiate a transmission opportunity). That is, regardless of whether ICF or ICR exchange is used to initiate OBSS transmission opportunity, NPCA may be allowed (such as the STAs may be configured to switch to the O-Primary channel, including by receiving an indication from an AP) if the length of the OBSS PPDU exceeds a threshold (NPCA_PPDU_Length_Threshold). For example, an AP may configure the STAs (such as by transmitting an indication, including in one or more beacons) to switch to the O-Primary channel regardless of whether ICF or ICR exchange is used to initiate OBSS transmission opportunity. NPCA-capable STAs may switch back to the M-Primary channel before the PPDU length expires. This may include any switching delays incurred by the AP or the STA.

Additionally, or alternatively, switching to the second primary channel 502-b (such as NPCA behavior) may be allowed both in the first case (where ICF or ICR is detected) and in the second case (where ICF or ICR is not used to initiate a transmission opportunity). For example, an AP may configure the STAs (such as by transmitting an indication, including in one or more beacons) to switch to the O-Primary channel if ICF or ICR is detected or if ICF or ICR is not used to initiate a transmission opportunity. In such cases, if OBSS transmission opportunity is initiated with an ICF and the duration of transmission opportunity protected by the ICF being greater than or equal to a threshold value (such as NPCA_NAV_Threshold), then the STA may determine that switching to the second primary channel 502-b (such as NPCA behavior) is permitted. In such cases, the NPCA-capable STA may switch back to the M-Primary channel before the NAV expires. This may include any switching delays incurred by the AP or the STA. However, if ICF is not used or if ICF is used, but duration of protected transmission opportunity is less than the threshold value (such as NPCA_NAV_Threshold), and if the length of the OBSS PPDU exceeds the threshold (such as NPCA_PPDU_Length_Threshold), then switching to the second primary channel 502-b (such as NPCA behavior) may be allowed. In such cases, the NPCA-capable STA may switch back to the M-Primary channel before the PPDU length expires. This may include any switching delays incurred by the AP or the STA. Else, the STA may not be permitted to switch to the O-Primary channel.

In some examples, an NPCA AP (such as AP 102 support NPCA-capable STA 104) may announce one or more of frames that are to be considered as ICF or ICR (via NPCA_ICF_List and NPCA_ICR_List), minimum NAV announced by the ICF (via NPCA_NAV_Threshold) (i.e., if the NAV is shorter than this value, an NPCA-capable STA may not switch to the O-Primary channel), maximum time taken to transmit ICR (via max_ICR_Time), minimum PPDU length (via NPCA_PPDU_Length_Threshold) (i.e., if the PPDU length is shorter than this value, an NPCA-capable STA may not switch to the O-Primary channel), processing or detection time of PPDUs (via NPCA_PPDU_proc_delay or NPCA_interBSS_Detection_Delay).

In a first example, an OBSS TXOP may be initiated with an ICF, where an NAV protects the entire transmission opportunity. In this example, the transmission opportunity holder may transmit (one or more) long PPDUs (such as having a length greater than NPCA_PPDU_Length_Threshold). In some examples, NPCA is allowed only for the first case (where ICF or ICR is detected), the NPCA-capable STA that detects ICF or ICR or both may observe the NAV from the ICF (or ICR). It may then determine that the NAV is greater than NPCA_NAV_Threshold and may determine that switch to O-Primary is allowed. The NPCA-capable STA, in this case, may switch to the O-Primary channel based on determining that a threshold duration has elapsed from an end of the frame (such as ICF/ICR) initiating the transmission opportunity. The NPCA-capable STA may return to the M-Primary channel by the time the NAV expires.

If NPCA is allowed only for the second case (where ICF or ICR is not used to initiate a transmission opportunity), then the NPCA-capable STA may ignore the ICF and ICR as the length of these PPDUs may be less than NPCA_PPDU_Length_Threshold. In some examples, when length of a first PPDU (PPDU1) may be greater than a threshold (such as NPCA_PPDU_Length_Threshold), the NPCA-capable STA may switch to O-Primary after a threshold time, described in further detail with reference to FIG. 8. The NPCA-capable STA may return to the M-Primary channel by the time the PPDU ends.

If NPCA is allowed for both cases, since ICF precedes the long PPDU, the NPCA-capable STA may ignore ICF and ICR for length-based switch, since the length of these PPDUs is less than the threshold (such as NPCA_PPDU_Length_Threshold). However, since the NAV indicated in the ICF/ICR is greater than NPCA_NAV_Threshold, the determination to switch to the O-Primary channel may be based on the ICF/ICR exchange. In this case, the NPCA-capable STA may switch to the O-Primary channel based on determining that a threshold duration has elapsed from an end of the frame (such as ICF/ICR) initiating the transmission opportunity. The NPCA-capable STA may return to the M-Primary channel by the time the NAV expires.

In a second example, an OBSS TXOP may be initiated with an ICF, where an NAV does not protect entire transmission opportunity. The transmission opportunity holder may transmit (one or more) long PPDUs (such as having a length greater than NPCA_PPDU_Length_Threshold). In some examples, NPCA is allowed only for the first case (where ICF or ICR is detected), the NPCA-capable STA that detects ICF or ICR or both may observe the NAV from the ICF (or ICR). The NPCA-capable STA may determine that the NAV is less than NPCA_NAV_Threshold and may determine that switch to the O-Primary channel is not allowed. Hence, the NPCA-capable STA may not switch to the O-Primary channel for this OBSS transmission opportunity.

If NPCA is allowed only for the second case (where ICF or ICR is not used to initiate a transmission opportunity), then the NPCA-capable STA may ignore ICF and ICR since the length of these PPDUs is less than NPCA_PPDU_Length_Threshold. Since the length of PPDU1 is greater than NPCA_PPDU_Length_Threshold, the NPCA-capable STA may switch to the O-Primary channel after a threshold time, described in further detail with reference to FIG. 8. The NPCA-capable STA may return to the M-Primary channel by the time the PPDU ends.

If NPCA is allowed for both cases, since ICF precedes the long PPDU, the NPCA-capable STA may ignore ICF and ICR for length-based switch since the length of these PPDUs is less than NPCA_PPDU_Length_Threshold. Moreover, since the NAV is less than NPCA_NAV_Threshold, based on the ICF/ICR exchange, the NPCA-capable STA may determine not to switch to O-Primary. When PPDU1 is detected, and since length of PPDU1 is greater NPCA_PPDU_Length_Threshold, the NPCA-capable STA may switch to the O-Primary channel after a threshold time, described in further detail with reference to FIG. 8. The NPCA-capable STA may return to the M-Primary channel by the time the PPDU ends.

In a third example, an OBSS TXOP may be initiated with an ICF, where an NAV protects entire transmission opportunity. The transmission opportunity holder may transmit multiple short PPDUs (such as having a length smaller than NPCA_PPDU_Length_Threshold). In this case, NPCA is allowed only for the first case (where ICF or ICR is detected), the NPCA-capable STA that detects ICF or ICR or both may observe the NAV from the ICF (or ICR). The NPCA-capable STA may determine that the NAV is greater than NPCA_NAV_Threshold and may determine that switch to O-Primary is allowed. The NPCA-capable STA may switch to O-Primary based on determining that a threshold duration has elapsed from an end of the frame (such as ICF/ICR) initiating the transmission opportunity. The NPCA-capable STA may return to M-Primary by the time the NAV expires.

If NPCA is allowed only for the second case (where ICF or ICR is not used to initiate a transmission opportunity), then the NPCA-capable STA may ignore ICF and ICR since the length of these PPDUs is less than NPCA_PPDU_Length_Threshold. Since the length of each of PPDU1, PPDU2, and PPDU3 is less than NPCA_PPDU_Length_Threshold, the NPCA-capable STA may not switch to O-Primary for any of the OBSS PPDUs. Thus, the NPCA-capable STA may not switch to O-Primary for this OBSS transmission opportunity.

If NPCA is allowed for both cases, since ICF precedes the PPDUs, the NPCA-capable STA may ignore ICF and ICR for length-based switch since the length of these PPDUs is less than NPCA_PPDU_Length_Threshold. However, since the NAV is greater than NPCA_NAV_Threshold, the determination to switch to O-Primary may be based on the ICF/ICR exchange. The NPCA-capable STA may switch to O-Primary determining that a threshold duration has elapsed from an end of the frame (such as ICF/ICR) initiating the transmission opportunity. The NPCA-capable STA may return to M-Primary by the time the NAV expires.

In a fourth example, an OBSS TXOP may be initiated with an ICF, where an NAV does not protect entire transmission opportunity (set incrementally). The transmission opportunity holder may transmit multiple short PPDUs (such as having a length smaller than NPCA_PPDU_Length_Threshold). In some examples, NPCA is allowed only for the first case (where ICF or ICR is detected), the NPCA-capable STA that detects ICF or ICR or both may observe the NAV from the ICF (or ICR). The NPCA-capable STA may determine that the NAV is less than NPCA_NAV_Threshold and determine that switch to O-Primary is not allowed. Hence, the NPCA-capable STA may not switch to O-Primary for this OBSS transmission opportunity.

If NPCA is allowed only for the second case (where ICF or ICR is not used to initiate a transmission opportunity), then the NPCA-capable STA may ignore ICF and ICR since the length of these PPDUs is less than NPCA_PPDU_Length_Threshold. Since the length of each of PPDU1, PPDU2, and PPDU3 is less than NPCA_PPDU_Length_Threshold, the NPCA-capable STA may not switch to O-Primary for any of the OBSS PPDUs. Thus, the NPCA-capable STA may not switch to O-Primary for this OBSS transmission opportunity.

If NPCA is allowed for both cases, since ICF precedes the PPDUs, the NPCA-capable STA may ignore ICF and ICR for length-based switch since the length of these PPDUs is less than NPCA_PPDU_Length_Threshold. Moreover, since the NAV is less than NPCA_NAV_Threshold in each PPDU, the NPCA-capable STA may determine that switch to O-Primary is not allowed. Furthermore, since the length of each of PPDU1, PPDU2, and PPDU3 is less than NPCA_PPDU_Length_Threshold, the NPCA-capable STA may not switch to O-Primary for any of the OBSS PPDUs. Thus, the NPCA-capable STA may not switch to O-Primary for this OBSS transmission opportunity.

In a fifth example, an OBSS TXOP may be initiated with an ICF, where an NAV does not protect entire transmission opportunity (set incrementally). The transmission opportunity holder may transmit multiple short PPDUs (such as having a length smaller than NPCA_PPDU_Length_Threshold). In some examples, NPCA is allowed only for the first case (where ICF or ICR is detected), the NPCA-capable STA that detects ICF or ICR or both may observe the NAV from the ICF (or ICR). The NPCA-capable STA may determine that the NAV is less than NPCA_NAV_Threshold and may determine that switch to O-Primary is not allowed. Hence, the NPCA-capable STA may not switch to O-Primary for this OBSS transmission opportunity.

If NPCA is allowed only for the second case (where ICF or ICR is not used to initiate a transmission opportunity), then the NPCA-capable STA may ignore ICF and ICR since the length of these PPDUs is less than NPCA_PPDU_Length_Threshold. Since the length of each of PPDU1, PPDU2, and PPDU3 is less than NPCA_PPDU_Length_Threshold, the NPCA-capable STA may not switch to O-Primary for any of the OBSS PPDUs. Thus, the NPCA-capable STA may not switch to O-Primary for this OBSS transmission opportunity.

If NPCA is allowed for both cases, since ICF precedes the PPDUs, the NPCA-capable STA may ignore ICF and ICR for length-based switch since the length of these PPDUs is less than NPCA_PPDU_Length_Threshold. Moreover, since the NAV is less than NPCA_NAV_Threshold in each PPDU, the NPCA-capable STA may determine that switch to O-Primary is not allowed. Furthermore, since the length of each of PPDU1, PPDU2, and PPDU3 is less than NPCA_PPDU_Length_Threshold, the NPCA-capable STA may not switch to O-Primary for any of the OBSS PPDUs. Thus, the NPCA-capable STA may not switch to O-Primary for this OBSS transmission opportunity.

In a sixth example, an OBSS TXOP may be initiated with an ICF, where an NAV does not protect entire transmission opportunity (set incrementally). The transmission opportunity holder may transmit multiple long PPDUs (such as having a length greater than NPCA_PPDU_Length_Threshold). In some examples, NPCA is allowed only for the first case (where ICF or ICR is detected), the NPCA-capable STA that detects ICF or ICR or both may observe the NAV from the ICF (or ICR). The NPCA-capable STA may determine that the NAV is greater than NPCA_NAV_Threshold and may determine that switch to O-Primary is allowed. Hence, the NPCA-capable STA may switch to O-Primary channel based on determining that a threshold duration has elapsed from an end of the frame (such as ICF/ICR) initiating the transmission opportunity. The NPCA-capable STA may return to the M-Primary channel by the time the NAV expires. For the subsequent PPDUs, (i.e., PPDU2, PPDU3), since they are not preceded with an ICF/ICR exchange, the NPCA-capable STA may not switch to O-Primary.

If NPCA is allowed only for the second case (where ICF or ICR is not used to initiate a transmission opportunity), then the NPCA-capable STA may ignore ICF and ICR since the length of these PPDUs is less than NPCA_PPDU_Length_Threshold. Since the length of each of PPDU1, PPDU2, and PPDU3 is greater than NPCA_PPDU_Length_Threshold, the NPCA-capable STA may switch to O-Primary and back to M-Primary multiple times. First, it may switch to O-Primary and return to M-Primary. Next, it may again switch to O-Primary and return to M-Primary. Finally, it may again switch to O-Primary and return to M-Primary.

If NPCA is allowed for both cases, since ICF precedes the PPDUs, the NPCA-capable STA may ignore ICF and ICR for length-based switch since the length of these PPDUs is less than NPCA_PPDU_Length_Threshold. However, since the NAV is greater than NPCA_NAV_Threshold, the NPCA-capable STA may switch to O-Primary based on determining that a threshold duration has elapsed from an end of the frame (such as ICF/ICR) initiating the transmission opportunity. The NPCA-capable STA may return to the M-Primary channel by the time the NAV expires. Thereafter, since the length of each of PPDU2, and PPDU3 is greater than

NPCA_PPDU_Length_Threshold, the NPCA-capable STA may switch to O-Primary and back to M-Primary multiple times. First, it may switch to O-Primary and return to M-Primary. Finally, it may again switch to O-Primary and return to M-Primary.

In a seventh example, an OBSS TXOP may not be initiated with an ICF. The transmission opportunity holder may transmit one (or more) long PPDUs (such as having a length greater than NPCA_PPDU_Length_Threshold). In some examples, NPCA is allowed only for the first case (where ICF or ICR is detected), since no ICF/ICR precedes the long PPDU, the NPCA-capable STA may not switch to O-Primary.

If NPCA is allowed only for the second case (where ICF or ICR is not used to initiate a transmission opportunity), since the length of PPDU1 is greater than NPCA_PPDU_Length_Threshold, the NPCA-capable STA may switch to O-Primary after a threshold time, described in further detail with reference to FIG. 8. The NPCA-capable STA may return to the M-Primary channel by the time the PPDU ends.

If NPCA is allowed for both cases, since no ICF/ICR precedes the long PPDU, the NPCA-capable STA use PPDU length to determine if switch to O-Primary is permitted. If the length of PPDU1 is greater than NPCA_PPDU_Length_Threshold, the NPCA-capable STA may switch to O-Primary after a threshold time, described in further detail with reference to FIG. 8. The NPCA-capable STA may return to the M-Primary channel by the time the PPDU ends.

In an eight example, an OBSS TXOP may not be initiated with an ICF. The transmission opportunity holder may transmit multiple short PPDUs (such as having a length smaller than NPCA_PPDU_Length_Threshold). In some examples, NPCA is allowed only for the first case (where ICF or ICR is detected), since no ICF/ICR precedes the long PPDU, the NPCA-capable STA may not switch to O-Primary for any of the OBSS PPDUs. Thus, the NPCA STA will not switch to O-Primary for this OBSS transmission opportunity.

If NPCA is allowed only for the second case (where ICF or ICR is not used to initiate a transmission opportunity), since the length of each of PPDU1, PPDU2, and PPDU3 is less than NPCA_PPDU_Length_Threshold, the NPCA-capable STA may not switch to O-Primary for any of the OBSS PPDUs.

If NPCA is allowed for both cases, since no ICF/ICR precedes the long PPDU, the NPCA-capable STA may use PPDU length to determine if switch to O-Primary is permitted. Since the length of each of PPDU1, PPDU2, and PPDU3 is less than NPCA_PPDU_Length_Threshold, the NPCA-capable STA may not switch to O-Primary for any of the OBSS PPDUs.

In a ninth example, an OBSS TXOP may be initiated with an ICF, where an NAV is long but does not protect entire transmission opportunity. The transmission opportunity holder may transmit (one or more) long PPDUs (such as having a length greater than NPCA_PPDU_Length_Threshold). In some examples, NPCA is allowed only for the first case (where ICF or ICR is detected), the NPCA-capable STA that detects ICF or ICR or both may observe the NAV from the ICF (or ICR). The NPCA-capable STA may determine that the NAV is greater than NPCA_NAV_Threshold and may determine that switch to the O-Primary channel is allowed. Hence, the NPCA-capable STA may switch to the O-Primary channel for this OBSS transmission opportunity. When the NPCA-capable STA switches back, if the signal strength of the OBSS PPDU is less than ED_threshold, the NPCA-capable STA may conclude that the M-Primary is idle and interfere with the reception of PPDU1 at the OBSS transmission opportunity responder.

If NPCA is allowed only for the second case (where ICF or ICR is not used to initiate a transmission opportunity), then the NPCA-capable STA may ignore ICF and ICR since the length of these PPDUs is less than NPCA_PPDU_Length_Threshold. Since the length of PPDU1 is greater than NPCA_PPDU_Length_Threshold, the NPCA-capable STA may switch to the O-Primary channel after a threshold time, described in further detail with reference to FIG. 8. The NPCA-capable STA may return to the M-Primary channel by the time the PPDU ends.

If NPCA is allowed for both cases, since ICF precedes the long PPDU, the NPCA-capable STA may ignore ICF and ICR for length-based switch since the length of these PPDUs is less than NPCA_PPDU_Length_Threshold. Moreover, since the NAV is greater than NPCA_NAV_Threshold, based on the ICF/ICR exchange, the NPCA-capable STA may determine to switch to O-Primary. Hence, the NPCA-capable STA may switch to the O-Primary channel for this OBSS transmission opportunity. When the NPCA-capable STA switches back, if the signal strength of the OBSS PPDU is less than ED_threshold, the NPCA-capable STA may conclude that the M-Primary is idle and interfere with the reception of PPDU1 at the OBSS transmission opportunity responder.

In a tenth example, an OBSS TXOP may be initiated with an ICF, where an NAV is long but overprotects the transmission opportunity. The transmission opportunity holder may transmit (one or more) short PPDUs (such as having a length smaller than NPCA_PPDU_Length_Threshold). In some examples, NPCA is allowed only for the first case (where ICF or ICR is detected), the NPCA-capable STA that detects ICF or ICR or both may observe the NAV from the ICF (or ICR). The NPCA-capable STA may determine that the NAV is greater than NPCA_NAV_Threshold and may determine that switch to the O-Primary channel is allowed. Hence, the NPCA-capable STA may switch to the O-Primary channel for this OBSS transmission opportunity. The NPCA-capable STA may return to M-Primary by the time the NAV expires. However, the OBSS transmission opportunity may have ended before, and the NPCA-capable STA may be blind on M-Primary. The NPCA-capable AP may ideally perform medium synchronization recovery but the NPCA-capable STA may be unaware that it has gone blind on M-Primary. This can lead to poor performance on M-Primary.

If NPCA is allowed only for the second case (where ICF or ICR is not used to initiate a transmission opportunity), then the NPCA-capable STA may ignore ICF and ICR since the length of these PPDUs is less than NPCA_PPDU_Length_Threshold. Since the length of PPDU1 is less than NPCA_PPDU_Length_Threshold, the NPCA-capable STA may not switch to the O-Primary channel.

If NPCA is allowed for both cases, since ICF precedes the long PPDU, the NPCA-capable STA that detects ICF or ICR or both may observe the NAV from the ICF (or ICR). The NPCA-capable STA may determine that the NAV is greater than NPCA_NAV_Threshold and may determine that switch to the O-Primary channel is allowed. Hence, the NPCA-capable STA may switch to the O-Primary channel for this OBSS transmission opportunity, potentially remaining blind (unaware of transmissions) on the M-Primary.

FIG. 6 shows an example of wireless communications 600 that support NPCA switching conditions. FIG. 6 may implement or be implemented to realize one or more aspects of the wireless communication network 100, the PDU 200, the PPDU 350, the wireless communication system 500, or any combination thereof. For example, FIG. 6 illustrates communication between a first wireless communication device and a second wireless communication device, which may be examples of the AP 102 or the STA 104, respectively, as described with reference to FIGS. 1 and 5. Additionally, or alternatively, the first wireless communication device and the second wireless communication device may communicate on the first primary channel and the second primary channel, which may be examples of the first primary channel 502-a and the second primary channel 502-b as described with reference to FIG. 5.

In some examples, the first wireless communication device may determine when to switch to a second primary channel based on receiving an ICF 602 or an ICR 604 or both. The first wireless communication device may receive, from a second wireless communication device and on a first primary channel, an indication of a frame (such as ICF 602 or ICR 604) initiating a transmission opportunity associated with an upcoming data transmission on the first primary channel. The first wireless communication device (AP or STA) may initiate a transmission opportunity with an ICF/ICR exchange. Examples of ICF/ICR may include one or more of RTS/CTS exchange, MU-RTS/CTS exchange (more prominent with EHT EMLSR devices), BSRP/buffer status report (BSR) exchange (more prominent with EHT EMLSR devices), short data frame/BA (such as BA 612-a and 612-b) exchange (in EHT EMLMR devices), and other trigger frame variants (such as more prominent in UHR due to power save/in-device coexistence usage), or any combination. In some cases, a duration field in MAC header of the ICF/ICR may protect the transmission opportunity. Such a duration field may indicate duration of upcoming data transmission on the first primary channel (NAV 606 indicated in ICF 602 or NAV 608 indicated in ICR 604). That is, a STA may indicate how long it intends to occupy the channel for its frame exchanges.

A STA, that is not the intended recipient of the ICF, that hears the ICF/ICR, may set its NAV equal to the value received in the duration field and may cease contention until the NAV expires. The recipient STA may also obtain the NAV information from the TXOP field of HE-SIG-A field if the PPDU is an HE PPDU or TXOP field of the U-SIG field if the PPDU is an EHT PPDU or UHR PPDU. If the NAV of an OBSS PPDU is heard by an NPCA STA on M-Primary, then the M-Primary may be considered as busy until the NAV expires. Thus, the STA can switch to the O-Primary and exchange frames with a peer NPCA STA until the end of the NAV.

One or more aspects depicted herein provide for determination of a time to switch to the O-primary channel. In some examples, presence of ICF on the medium may not guarantee a successful frame exchange. For instance, the responder may not send ICR. Thus, an NPCA-capable STA cannot switch after hearing ICF, and may switch after the presence of ICR is confirmed. However, each of the NPCA-capable STA may communicate after it hears only ICF 602, only ICR 604, or both 602 ICF and ICR 604. In general, an NPCA-capable STA cannot know which frames are heard by the peer STA. Thus, switch to O-Primary can be initiated only when PPDU1 610-a starts. An NPCA-capable STA that hears ICR 604 alone may not hear PPDU1 610-a. However, detection of ICR 604 with a long Duration field can be used to imply a preceding ICF and succeeding PPDU1 610-a.

According to the aspects depicted herein, an NPCA-capable STA may switch to a second primary channel based on determining that a threshold duration (614 or 616) has elapsed from an end of the frame initiating the transmission opportunity. For instance, an NPCA-capable STA that hears ICF 602 may initiate NPCA switch a duration of T1 following the end of the PPDU that carried the ICF, where T1= (2×aSIFSTime)+ICR_Time+aRxPHYStartDelay. There may be an additional condition that the NPCA-capable STA may receive a PHY-RXSTART.indication primitive within the latest (aSIFSTime+aRxPHYStartDelay) before T1 expires. This ensures that switch is initiated only if ICR 604 is received in response to ICF 602. There may be an additional (2×aSlotTime) added to T1, i.e., T1=(2×aSlotTime)+(2×aSIFSTime)+ICR_Time+aRxPHYStartDelay. In this case, the additional condition may be to receive a PHY-RXSTART.indication primitive within the latest (aSIFSTime+aRxPHYStartDelay+aSlotTime), before T1 expires.

An NPCA-capable STA that hears ICR 604 but not ICF 602, may initiate NPCA switch a duration of T2 following the end of the PPDU that carried the ICR 604, where T2=(aSIFSTime+aRxPHYStartDelay). There may be an additional (aSlotTime) added to T2, i.e., T2=(aSlotTime+aSIFSTime+aRxPHYStartDelay. In some examples, the NPCA-capable STA may switch sooner than T1 or T2 (as applicable) but may not be allowed to assume that the peer NPCA-capable STA has initiated the switch sooner than T1 or T2 (as applicable). In other words, the NPCA-capable STA that initiates the TXOP on O-Primary may consider peer STA's start of switching delay from M-Primary to O-Primary only after T1 or T2 (as applicable) has elapsed.

In some examples, the ICF 602 and ICR 604 may belong to a set of frames NPCA_ICF_List and NPCA_ICR_List. These lists may be pre-defined, or may be announced by the AP in Broadcast Management frames, or both. The specification of this list may be in terms of frame types/subtypes (such as NPCA_ICF_List={(MU-)RTS, Trigger frame (and its type), Block Ack Request} and NPCA_ICR_List={CTS, QoS Null, Block Ack}, frame length satisfying a pre-defined or AP-defined condition (such as frame duration smaller than X usec or frame length smaller than Y bytes), or both (such as frame of type Control with duration smaller than X usec). In such cases, the NAV indicated in the frame may be greater than NPCA_NAV_Threshold. The NPCA_NAV_Threshold may be pre-defined, or may be announced by the AP in Broadcast Management frames, or both. It may be possible that NPCA_NAV_Threshold=0, which would mean that an NPCA STA can transmit on O-Primary as long as it can fit at least one MPDU (and potentially its response). The NAV may be indicated in the duration field of MAC header, TXOP field of PHY preamble in HE, EHT, or UHR PPDUs, or both.

In some examples, if the NPCA-capable STA receives the NAV information field from both duration field and TXOP field, then the NPCA-capable STA may follow one of the following rules. As a first rule, the NPCA-capable STA may consider the NAV from the TXOP field (TXOP field may be more robust and may indicate a shorter value than the duration field). As a second rule, the NPCA-capable STA may consider the NAV from the duration field. As a third rule, depending on frame type, for certain frames, the NPCA-capable STA may consider the TXOP field, while for others it may consider the duration field.

In some examples, the NPCA-capable STA may determine ICR_Time in computation of T1. ICR_Time may be used if the NPCA-capable STA does not receive ICR 604. If ICR 604 is received, then the NPCA-capable STA may use T2 following the PPDU carrying the ICR 604 to initiate the NPCA switch. To determine the ICR_Time, if ICF is RTS or MU-RTS, ICR_Time is the time taken to transmit the CTS frame at 6 Mbps. However, if ICF is not RTS or MU-RTS, then ICR_Time may not be accurately determined without receiving it. In this case, the NPCA-capable STA may initiate two timers, which may start counting down at the end of the PPDU carrying the ICF frame, Timer_1 with the value (aSIFSTime+aSlotTime+aRxPHYStartDelay) and Timer_2 with the value (2×aSIFSTime+max_ICF_Time+aRxPHYStartDelay), where max_ICF_Time is a value defined in the spec or by the AP (or both) considering the time taken to transmit the longest ICR frame at the lowest PHY rate of 6 Mbps. For example, if BAR/BA is considered a valid ICF/ICR exchange, then max_ICF_Time may be the time taken to transmit a 1024/4096 bitmap Block Ack at 6 Mbps. The value of max_ICF_Time may depend on NPCA_ICF_List, NPCA_ICR_List, or both. Alternatively, an AP may advertise the value by which Timer_2 may be initialized.

If the MAC of the NPCA-capable STA receives a PHY-RXSTART.indication primitive before Timer_1 expires, then it may be determined that the NPCA-capable STA has received the ICR, and therefore follows T2 to initiate the NPCA switch. Otherwise, if the MAC of the NPCA-capable STA receives a PHY-RXSTART.indication primitive after Timer_1 expires but before Timer_2 expires, the NPCA-capable STA may initiate the switch to O-Primary immediately. Otherwise, if the MAC does not receive a PHY-RXSTART.indication primitive before Timer_2 expires, then the NPCA-capable STA may not initiate the switch to the O-Primary channel (i.e., forego the O-Primary TXOP opportunity as if the ICF was never received).

To have more determinism on when the NPCA-capable STAs switch, the value of aRxPHYStartDelay may be fixed to a value. For example, aRxPHYStartDelay may be fixed to 20 usec. This method of determining when to switch to O-Primary may maximizes NPCA gains in certain cases. If OBSS STA sets a large NAV and uses the duration, the entire duration can be used on O-Primary for NPCA. In some cases, ICF is not used at all, and in many cases, NAV cannot be acquired. In some examples, ICF may be sent by the OBSS STA and may not protect entire OBSS transmission opportunity (or not even sufficiently large portion of OBSS transmission opportunity). In some cases, ICF or ICR or both may set Duration field to 0. Even if ICF sent by OBSS STA protects entire OBSS transmission opportunity, NPCA-capable STA may not be able to set the NAV. For example, if Duration field is encoded using high MCS, NPCA-capable STA may not be able to decode it. TXOP field in HE/EHT/UHR PPDU may be more reliable (robust MCS) but may not be available if the OBSS PPDU is not HE PPDU, EHT PPDU or UHR PPDU. In these cases, NPCA-capable STA may not know how long it may take to switch to O-Primary and may result in lost NPCA opportunities. In some cases, the NPCA-capable STA may not rely on the acquired transmission opportunity. The ICF may protect a large transmission opportunity without knowing how much duration it actually needs. Later, the STA may send CF-End to reset the NAV. This may affect the performance because NPCA AP and non-AP may have switched to O-Primary and may exchange frames for large duration, when, M-primary became idle much sooner. AP and non-AP STA may become blind (lose medium synchronization) on M-Primary, and may face collisions with other ongoing transmissions and/or incur delays due to medium synchronization recovery.

FIG. 7 shows an example of wireless communications 700 that support NPCA switching conditions. FIG. 7 may implement or be implemented to realize one or more aspects of the wireless communication network 100, the PDU 200, the PPDU 350, the wireless communication system 500, or any combination thereof. For example, FIG. 7 illustrates communication between a first wireless communication device and a second wireless communication device, which may be examples of the AP 102 or the STA 104, respectively, as described with reference to FIGS. 1 and 5. Additionally, or alternatively, the first wireless communication device and the second wireless communication device may communicate on the first primary channel and the second primary channel, which may be examples of the first primary channel 502-a and the second primary channel 502-b as described with reference to FIG. 5.

In some examples, STAs may not use ICF/ICR based initial frame exchange. Any MPDUs that are to be sent by the transmission opportunity holder may be sent within a single long PPDU. In such cases, a NAV based switch may not be efficient because the duration field in the long PPDU may cover only until the end of a Block Ack frame. In such scenarios, the NPCA-capable STAs may implement a PPDU-length based switch. The PPDU-length may be indicated in the L-SIG field of the PHY header. Before switching to O-Primary, the NPCA-capable STA may detect whether the PPDU is an OBSS PPDU. Such detection may be based on one or more rules classifying a PPDU as inter-BSS PPDU (i.e., OBSS PPDU) or intra-BSS PPDU. The NPCA-capable STA may can leverage these rules to determine whether a PPDU (such as PPDU 708) is an inter-BSS PPDU or intra-BSS PPDU. A NPCA-capable STA may classify a received PPDU as an inter-BSS PPDU if the BSS color is not disabled and the RXVECTOR parameter BSS_COLOR is not 0 and is not the BSS color of the BSS of which the STA is a member. NPCA-capable STA may classify a received PPDU as an inter-BSS PPDU if the PPDU is a VHT PPDU with RXVECTOR parameter PARTIAL_AID not equal to the BSSID[39:47] of the BSS in which the STA is associated or any of the other BSSs in the same multiple BSSID set or co-hosted BSSID set to which its BSS belongs and the RXVECTOR parameter GROUP_ID is 0. In some cases, the NPCA-capable STA may classify a received PPDU as an inter-BSS PPDU if the PPDU is a VHT PPDU with RXVECTOR parameter PARTIAL_AID[5:8] not equal to the 4 LSBs of the BSS color announced by the BSS of which the STA whose dot11PartialBSSColorImplemented is equal to true is a member and RXVECTOR parameter GROUP_ID equal to 63 when the Partial BSS Color field in the most recent HE Operation element is 1.

In some cases, the NPCA-capable STA may classify a received PPDU as an inter-BSS PPDU if the PPDU is either a VHT MU PPDU or an HE MU PPDU with the RXVECTOR parameter UPLINK_FLAG equal to 0, and the STA is an AP. In some cases, the NPCA-capable STA may classify a received PPDU as an inter-BSS PPDU if the PPDU carries a frame that has a BSSID field, the value of which is not the BSSID of the BSS in which the STA is associated or any of the other BSSs in the same multiple BSSID set or co-hosted BSSID set to which its BSS belongs or the wildcard BSSID. In some cases, the NPCA-capable STA may classify a received PPDU as an inter-BSS PPDU if the PPDU carries a frame that does not have a BSSID field but has both an RA field and TA field, neither value of which is equal to the BSSID of the BSS in which the STA is associated or any of the other BSSs in the same multiple BSSID set or co-hosted BSSID set to which its BSS belongs. In some cases, the individual/group bit in the TA field may be forced to 0 prior to comparison.

In some cases, the NPCA-capable STA may classify a received PPDU as an intra-BSS PPDU if the BSS color is not disabled and the RXVECTOR parameter BSS_COLOR is the BSS color of the BSS of which the STA is a member or the BSS color of any TDLS direct links to which the STA belongs if the STA is an HE STA associated with a non-HE AP. In some cases, the NPCA-capable STA may classify a received PPDU as an intra-BSS PPDU if the PPDU is a VHT PPDU with RXVECTOR parameter PARTIAL_AID equal to the BSSID[39:47] of the BSS in which the STA is associated or any of the other BSSs in the same multiple BSSID set or co-hosted BSSID set to which its BSS belongs and the RXVECTOR parameter GROUP_ID equal to 0. In some cases, the NPCA-capable STA may classify a received PPDU as an intra-BSS PPDU if the PPDU is a VHT PPDU with RXVECTOR parameter PARTIAL_AID[5:8] equal to the 4 LSBs of the BSS color announced by of the BSS of which the STA whose dot11PartialBSSColorImplemented is equal to true is a member, the RXVECTOR parameter GROUP_ID is equal to 63, and the Partial BSS Color field in the most recent HE Operation element is 1.

In some cases, the NPCA-capable STA may classify a received PPDU as an intra-BSS PPDU if the PPDU carries a frame that has an RA, TA, or BSSID field value that is equal to the BSSID of the BSS or the BSSID of any BSS in which the STA is associated or any of the other BSSs in the same multiple BSSID set or co-hosted BSSID set to which its BSS belongs. The Individual/Group bit in the TA field is forced to 0 prior to the comparison. In some cases, the NPCA-capable STA may classify a received PPDU as an intra-BSS PPDU if the PPDU carries a Control frame that does not have a TA field and that has an RA field value that matches the saved TXOP holder address of the BSS or any BSS in which the STA is associated or any of the other BSSs in the same multiple BSSID set or co-hosted BSSID set to which its BSS belongs. In some cases, the NPCA-capable STA may classify a received PPDU as an intra-BSS PPDU if, based on the MAC address information of a frame carried in a received PPDU, the received PPDU satisfies both intra-BSS and inter-BSS conditions, then the received PPDU is classified as an intra-BSS PPDU. In some cases, the NPCA-capable STA may classify a received PPDU as an intra-BSS PPDU if the received PPDU satisfies the intra-BSS conditions using the RXVECTOR parameter BSS_COLOR and also satisfies the inter-BSS conditions using MAC address information of a frame carried in the PPDU, then the classification made using the MAC address information takes precedence.

To perform the NPCA switch to O-Primary, the NPCA-capable STA may know the maximum duration for which frame exchanges are permitted on O-Primary and when to switch to the O-Primary. To determine the maximum duration for which frame exchanges are permitted on O-Primary, the NPCA-capable STA may decode the Length subfield of the L-SIG field 706. The L-SIG field 706 may be present in the early portion of the PPDU 708.

The AP (or it may be predefined) may specify a threshold value of the PPDU Length 710 as NPCA_PPDU_Length_Threshold. The NPCA-capable STA may use the length 710 to determine whether NPCA switch is to be initiated. It may be possible that NPCA_PPDU_Length_Threshold=0, which may mean that an NPCA-capable STA can transmit on O-Primary as long as it can fit at least one MPDU (and potentially its response).

To determine when to switch to the O-Primary, the NPCA-capable STA may determine that the PPDU is an inter-BSS PPDU. An NPCA-capable STA may not switch to O-Primary if it cannot classify the PPDU as inter-BSS PPDU. This may imply that if the NPCA-capable STA classifies the PPDU as intra-BSS PPDU or if the PPDU cannot be classified, it may not switch. Based on the PPDU type, there may be a certain field in the PPDU (in the PHY header or MAC header), which, when decoded, the NPCA-capable STA can determine whether the PPDU is an intra-BSS or inter-BSS PPDU. For example, if the PPDU is an UHR PPDU, EHT PPDU, HE PPDU, the PPDU is determined as intra-BSS or inter-BSS based on the value carried in the BSS Color field of the HE-SIG-A field (if PPDU is HE PPDU) or the U-SIG field (if PPDU is EHT PPDU or UHR PPDU). By this time, the NPCA-capable STA may already know the maximum duration for which frame exchanges are permitted on O-Primary, and, therefore, can be considered as ready to switch.

Depending on the PPDU format used by the OBSS STAs and other settings, the earliest occurring field at which an NPCA STA can determine that the PPDU is an inter-BSS PPDU may be different. Moreover, the NPCA-capable STA may determine whether the PPDU is inter-BSS or intra-BSS based on different fields within the same PPDU. In some cases, the NPCA-capable STA may determine the whether the PPDU is inter-BSS or intra-BSS in accordance with a precedence order. The AP may define the precedence order (or it may be predefined). Thus, if the OBSS PPDU is an HE PPDU and the BSS color is enabled, then each NPCA-capable STA may determine the status of the PPDU based only on the HE-SIG-A field and no other field.

According to one or more aspects depicted herein, the NPCA-capable STA may receive an indication of a PPDU associated with an upcoming data transmission on the first primary channel, the PPDU including a header portion (including STF 702, LTF 704 and SIG 706) and a data portion. The NPCA-capable STA may switch to a second primary channel based on a length of the PPDU satisfying a threshold value and on the PPDU being an inter-BSS PPDU. In this case, the NPCA-capable STA may operate using more reliable information, Value obtained from PPDU length may be more reliable because it is sent at low MCS. The transmitter may occupy the medium for the indicated duration (unlike NAV, where CF-End can terminate the transmission opportunity). Therefore, there may not be any issue of loss of medium synchronization on M-Primary.

The technique depicted herein provide for a deterministic way of setting the PPDU length, as opposed to NAV, which can have single/multiple protection settings and unpredictable behavior from legacy STAs. This technique may not use all gains. In some scenarios, an OBSS STA may use SIFS bursting within its TXOP. That is instead of transmitting a large PPDU, the STA may breaks the PPDU into multiple bursts. In such cases, either the NPCA-capable STA switches and switches back very often-incurring inefficiencies of switching delays and transmitting ICF/ICR (such as RTS/CTS) on O-Primary every time, or each individual PPDU may be too short for O-Primary to be meaningfully used and no NPCA opportunity may be available, even though the actual TXOP may be long.

In some examples, a pre-emption mechanism may also be implemented with short PPDU bursting. However, supporting the Dynamic Subband Operation mechanism, using which an AP may utilize the entire BSS BW. Thus, opportunities for NPCA may naturally diminish. In some cases, hidden node scenario or asymmetric view problem may be exacerbated. When switch is based on ICF/ICR (and the corresponding NAV), the peer NPCA STAs have two different PPDUs (one corresponding to ICF and another corresponding to ICR) from which they can detect the OBSS transmissions and extract the NAV. However, for PPDU length being used as basis for NPCA switch, both peer NPCA STAs may hear the same OBSS PPDU, which may increase the hidden node problem.

FIG. 8 shows an example of PPDUs 800 that support NPCA switching conditions. FIG. 8 may implement or be implemented to realize one or more aspects of the wireless communication network 100, the PDU 200, the PPDU 350, the wireless communication system 500, or any combination thereof. For example, FIG. 7 illustrates communication between a first wireless communication device and a second wireless communication device, which may be examples of the AP 102 or the STA 104, respectively, as described with reference to FIGS. 1 and 5. Additionally, or alternatively, the first wireless communication device and the second wireless communication device may communicate on the first primary channel and the second primary channel, which may be examples of the first primary channel 502-a and the second primary channel 502-b as described with reference to FIG. 5.

FIG. 8 depicts that an NPCA-capable STA may determine a time to switch to the second primary channel. For example, the NPCA-capable STA may initiate the switch immediately after receiving the field (at 802-a, 802-b, 802-c, and 802-d for different PPDUs) that leads to the determination that the PPDU is an inter-BSS PPDU. For example, if the PPDU is an HE PPDU, the NPCA-capable STA switches immediately after the receiving the HE-SIG-A field. Additionally, or alternatively, the NPCA-capable STA may initiate the switch immediately after receiving the field that leads to the determination that the PPDU is an inter-BSS PPDU plus an additional processing delay (such as NPCA_PPDU_proc_delay). As depicted in the example of FIG. 8, the NPCA-capable STA may initiate the switch at 804-a, 804-b, 804-c, and 804-d for different PPDUs. This may account for the fact that most implementations may take a finite time to process the fields received in the PPDU and initiate the switch. This delay may be exchanged between the NPCA-capable STAs or may be predefined.

Having decoded that the PPDU is an intra-BSS PPDU (at 806-a, 806-b, 806-c, and 806-d for different PPDUs), the NPCA-capable STA may initiate the switch at a fixed offset (such as NPCA_interBSS_Detection_Delay) from aRxPHYStartDelay. For example, regardless of the PPDU type, an NPCA-capable STA may switch to O-Primary 100 usec after aRxPHYStartDelay. In some examples, the NPCA-capable STAs may exchange this information during association and/or while enabling the NPCA mode. To have more determinism on when the NPCA-capable STAs switch, the value of aRxPHYStartDelay may be predefined (such as aRxPHYStartDelay=20 usec (i.e., end of L-SIG).

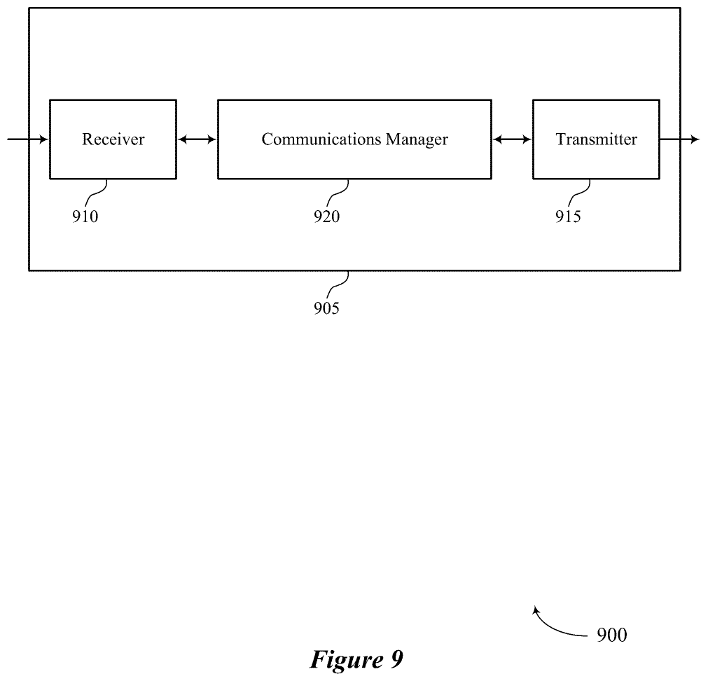

FIG. 9 shows a block diagram 900 of a device 905 that supports NPCA switching conditions in accordance with one or more aspects of the present disclosure. The device 905 may be an example of aspects of a STA as described herein. The device 905 may include a receiver 910, a transmitter 915, and a communications manager 920. The device 905, or one or more components of the device 905 (such as the receiver 910, the transmitter 915, the communications manager 920), may include at least one processor, which may be coupled with at least one memory, to, individually or collectively, support or enable the described techniques. Each of these components may be in communication with one another (such as via one or more buses).

The receiver 910 may provide a means for receiving information such as packets, user data, control information, or any combination thereof associated with various information channels (such as control channels, data channels, information channels related to NPCA switching conditions). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (such as control channels, data channels, information channels related to NPCA switching conditions). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of NPCA switching conditions as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (such as in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communications manager 920, the receiver 910, the transmitter 915, or various combinations or components thereof may be implemented in code (such as communications management software or firmware) executed by at least one processor (such as referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the communications manager 920 may be configured to perform various operations (such as receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for receiving, from a second wireless communication device and on a first primary channel, an indication of a frame initiating a transmission opportunity associated with an upcoming data transmission on the first primary channel. The communications manager 920 is capable of, configured to, or operable to support a means for switching to a second primary channel based on determining that a threshold duration has elapsed from an end of the frame initiating the transmission opportunity. The communications manager 920 is capable of, configured to, or operable to support a means for communicating on the second primary channel based on switching to the second primary channel.

Additionally, or alternatively, the communications manager 920 may support wireless communication in accordance with examples as disclosed herein. For example, the communications manager 920 is capable of, configured to, or operable to support a means for receiving, from a second wireless communication device and on a first primary channel, an indication of a PHY PPDU associated with an upcoming data transmission on the first primary channel, the PPDU including a header portion and a data portion. The communications manager 920 is capable of, configured to, or operable to support a means for switching to a second primary channel based on a length of the PPDU satisfying a threshold value and on the PPDU being an inter-BSS PPDU. The communications manager 920 is capable of, configured to, or operable to support a means for communicating on the second primary channel based on switching to the second primary channel.

By including or configuring the communications manager 920 in accordance with examples as described herein, the device 905 (such as at least one processor controlling or otherwise coupled with the receiver 910, the transmitter 915, the communications manager 920, or a combination thereof) may support techniques for reduced processing, reduced power consumption, and more efficient utilization of communication resources.

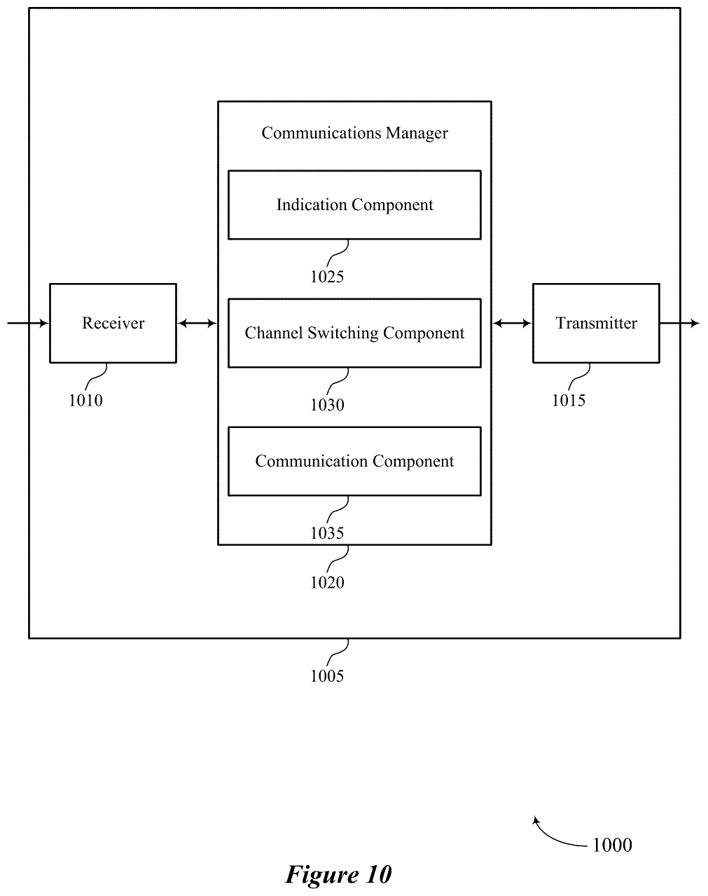

FIG. 10 shows a block diagram 1000 of a device 1005 that supports NPCA switching conditions in accordance with one or more aspects of the present disclosure. The device 1005 may be an example of aspects of a device 905 or a STA 104 as described herein. The device 1005 may include a receiver 1010, a transmitter 1015, and a communications manager 1020. The device 1005, or one or more components of the device 1005 (such as the receiver 1010, the transmitter 1015, the communications manager 1020), may include at least one processor, which may be coupled with at least one memory, to support the described techniques. Each of these components may be in communication with one another (such as via one or more buses).

The receiver 1010 may provide a means for receiving information such as packets, user data, control information, or any combination thereof associated with various information channels (such as control channels, data channels, information channels related to NPCA switching conditions). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (such as control channels, data channels, information channels related to NPCA switching conditions). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of NPCA switching conditions as described herein. For example, the communications manager 1020 may include an indication component 1025, a channel switching component 1030, a communication component 1035, or any combination thereof. The communications manager 1020 may be an example of aspects of a communications manager 920 as described herein. In some examples, the communications manager 1020, or various components thereof, may be configured to perform various operations (such as receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The indication component 1025 is capable of, configured to, or operable to support a means for receiving, from a second wireless communication device and on a first primary channel, an indication of a frame initiating a transmission opportunity associated with an upcoming data transmission on the first primary channel. The channel switching component 1030 is capable of, configured to, or operable to support a means for switching to a second primary channel based on determining that a threshold duration has elapsed from an end of the frame initiating the transmission opportunity. The communication component 1035 is capable of, configured to, or operable to support a means for communicating on the second primary channel based on switching to the second primary channel.

Additionally, or alternatively, the communications manager 1020 may support wireless communication in accordance with examples as disclosed herein. The indication component 1025 is capable of, configured to, or operable to support a means for receiving, from a second wireless communication device and on a first primary channel, an indication of a PHY PPDU associated with an upcoming data transmission on the first primary channel, the PPDU including a header portion and a data portion. The channel switching component 1030 is capable of, configured to, or operable to support a means for switching to a second primary channel based on a length of the PPDU satisfying a threshold value and on the PPDU being an inter-BSS PPDU. The communication component 1035 is capable of, configured to, or operable to support a means for communicating on the second primary channel based on switching to the second primary channel.

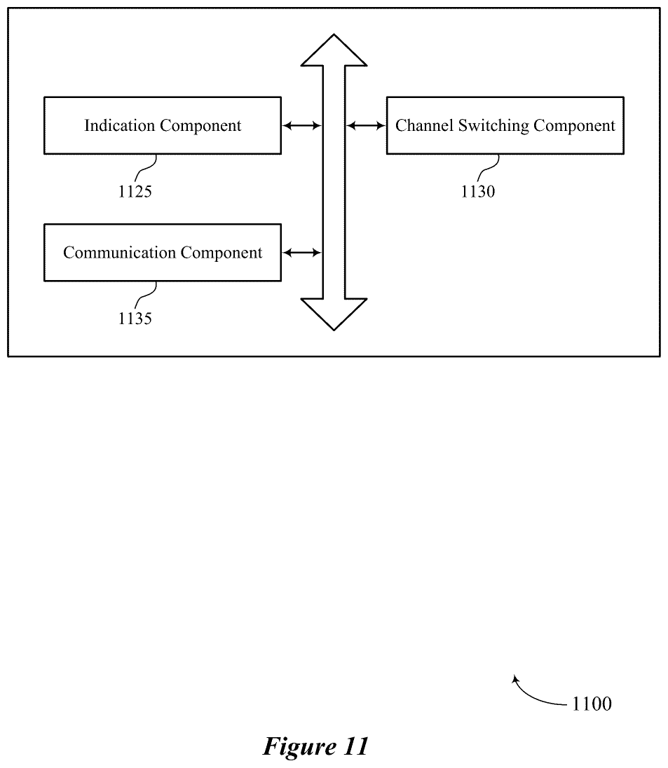

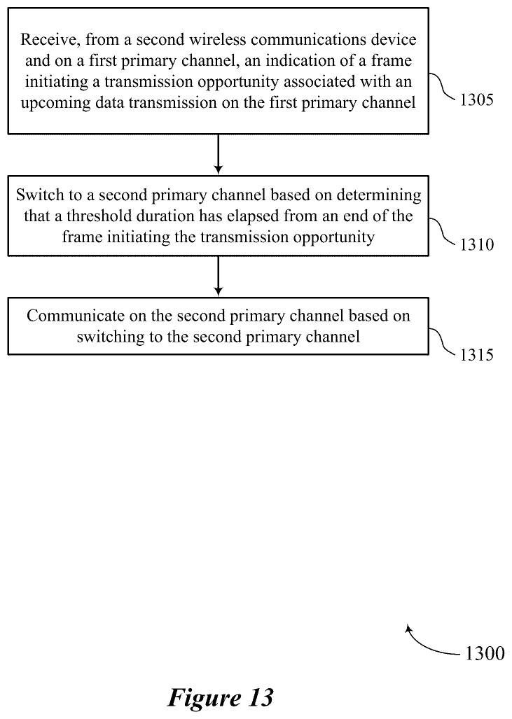

FIG. 11 shows a block diagram of an example wireless communication device 1100 that supports NPCA switching conditions. In some examples, the wireless communication device 1100 is configured to perform the processes 1300, 1400, 1500, and 1600 described with reference to FIGS. 13, 14, 15, and 16, respectively. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in a communications manager, such as the AP 102 or the STA 104 described with reference to FIG. 1. In some other examples, the wireless communication device 1100 can be a communications manager that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of PHY PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes a user interface (UI) (such as a touchscreen or keypad) and a display, which may be integrated with the UI to form a touchscreen display that is coupled with the processing system. In some examples, the wireless communication device 1100 may further include one or more sensors such as, for example, one or more inertial sensors, accelerometers, temperature sensors, pressure sensors, or altitude sensors, that are coupled with the processing system. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes an indication component 1125, a channel switching component 1130, and a communication component 1135. Portions of one or more of the indication component 1125, the channel switching component 1130, and the communication component 1135 may be implemented at least in part in hardware or firmware. For example, one or more of the indication component 1125, the channel switching component 1130, and the communication component 1135 may be implemented at least in part by at least a processor or a modem. In some examples, portions of one or more of the indication component 1125, the channel switching component 1130, and the communication component 1135 may be implemented at least in part by a processor and software in the form of processor-executable code stored in memory.

The wireless communication device 1100 may support wireless communication in accordance with examples as disclosed herein. The indication component 1125 is configurable or configured to receive, from a second wireless communication device and on a first primary channel, an indication of a frame initiating a transmission opportunity associated with an upcoming data transmission on the first primary channel. The channel switching component 1130 is configurable or configured to switch to a second primary channel based on determining that a threshold duration has elapsed from an end of the frame initiating the transmission opportunity. The communication component 1135 is configurable or configured to communicate on the second primary channel based on switching to the second primary channel.

In some examples, to support receiving the indication, the indication component 1125 is configurable or configured to receive, from the second wireless communication device and on the first primary channel, the indication of a short initial control frame including a duration of upcoming data transmission on the first primary channel, where the duration of upcoming data transmission on the first primary channel satisfies a threshold duration value.

In some examples, the channel switching component 1130 is configurable or configured to switch to the first primary channel before expiration of the duration of upcoming data transmission on the first primary channel. In some examples, the threshold duration includes a sum of an initial control frame time value, a receiver start delay time value, and two times a short interframe space time value.

In some examples, the indication of the short initial control frame is included in an initial control frame list. In some examples, the initial control frame list includes one or more of a request to send frame, a multi-user request to send frame, a trigger frame, a block acknowledgement request frame, or any combination thereof.

In some examples, the communication component 1135 is configurable or configured to initiate a first timer and a second timer upon receiving the indication of a short initial control frame, where a value of the first timer includes a sum of a short interframe space time value, a slot time value and a receiver start delay time value, and a value of the second timer includes a sum of two times the short interframe space time value, a maximum initial control frame time value and the receiver start delay time value, and where switching to the second primary channel is based on the first timer, on the second timer, or both.

In some examples, the indication component 1125 is configurable or configured to receive, from the second wireless communication device and on the first primary channel, a PHY reception start indication after expiry of the first timer and before expiry of the second timer, where switching to the second primary channel includes switching to the second primary channel before the expiry of the second timer based on receiving the PHY reception start indication.

In some examples, to support receiving the indication, the indication component 1125 is configurable or configured to receive, from the second wireless communication device and on the first primary channel, the indication of a short initial control response including a duration of upcoming data transmission on the first primary channel, where the duration of upcoming data transmission on the first primary channel satisfies a threshold duration value. In some examples, the threshold duration includes a sum of a receiver start delay time value and a short interframe space time value.

In some examples, the indication of the short initial control response is included in an initial control response list. In some examples, the initial control response list includes one or more of a clear to send frame, a quality of service indication, a block acknowledgement, or any combination thereof.

In some examples, the indication component 1125 is configurable or configured to receive an indication of a threshold duration value for a duration of upcoming data transmission on the first primary channel, where the indication includes a duration field of a medium access control (MAC) header, a transmission opportunity field of a physical preamble, or both.

In some examples, a frame length of the frame initiating the transmission opportunity satisfies a threshold length. In some examples, the threshold length is predefined or indicated to the first wireless communication device.

In some examples, the upcoming data transmission is transmitted as a set of multiple PHY PPDUs. In some examples, at least one PPDU of the set of multiple PPDUs fails to satisfy a PPDU length threshold. In some examples, the first primary channel includes a main primary channel, and the second primary channel includes an opportunistic primary channel. In some examples, the first wireless communication device includes a NPCA capable station.

Additionally, or alternatively, the wireless communication device 1100 may support wireless communication in accordance with examples as disclosed herein. In some examples, the indication component 1125 is configurable or configured to receive, from a second wireless communication device and on a first primary channel, an indication of a PHY PPDU associated with an upcoming data transmission on the first primary channel, the PPDU including a header portion and a data portion. In some examples, the channel switching component 1130 is configurable or configured to switch to a second primary channel based on a length of the PPDU satisfying a threshold value and on the PPDU being an inter-BSS PPDU. In some examples, the communication component 1135 is configurable or configured to communicate on the second primary channel based on switching to the second primary channel.

In some examples, the communication component 1135 is configurable or configured to decode a first field included in the header portion of the PPDU to identify the length of the PPDU. In some examples, the communication component 1135 is configurable or configured to decode a second field included in the header portion of the PPDU to identify that the PPDU is the inter-BSS PPDU, where the first field is located earlier than the second field in the header portion.

In some examples, to support switching to the second primary channel, the channel switching component 1130 is configurable or configured to switch to the second primary channel in response to decoding the second field included in the header portion of the PPDU to identify that the PPDU is the inter-BSS PPDU.

In some examples, to support switching to the second primary channel, the channel switching component 1130 is configurable or configured to switch to the second primary channel based on determining that a processing delay duration has elapsed after decoding the second field included in the header portion of the PPDU to identify that the PPDU is the inter-BSS PPDU.

In some examples, to support switching to the second primary channel, the channel switching component 1130 is configurable or configured to switch to the second primary channel based on determining that an offset duration has elapsed after decoding the first field included in the header portion of the PPDU to identify the length of the PPDU.

In some examples, the indication component 1125 is configurable or configured to receive, from a third wireless communication device, an indication of one or more of the threshold value, a processing delay duration, an offset duration, or any combination thereof.

In some examples, the indication component 1125 is configurable or configured to receive, from the second wireless communication device and on the first primary channel, an indication of a frame initiating a transmission opportunity associated with an upcoming data transmission on the first primary channel, the frame including a duration of upcoming data transmission on the first primary channel. In some examples, the channel switching component 1130 is configurable or configured to refrain from switching to the second primary channel in response to receiving the frame based on the duration of upcoming data transmission on the first primary channel not satisfying a threshold duration value.

In some examples, the frame includes a short initial control frame, or a short initial control response, or both. In some examples, the first primary channel includes a main primary channel, and the second primary channel includes an opportunistic primary channel. In some examples, the first wireless communication device includes a NPCA capable station.

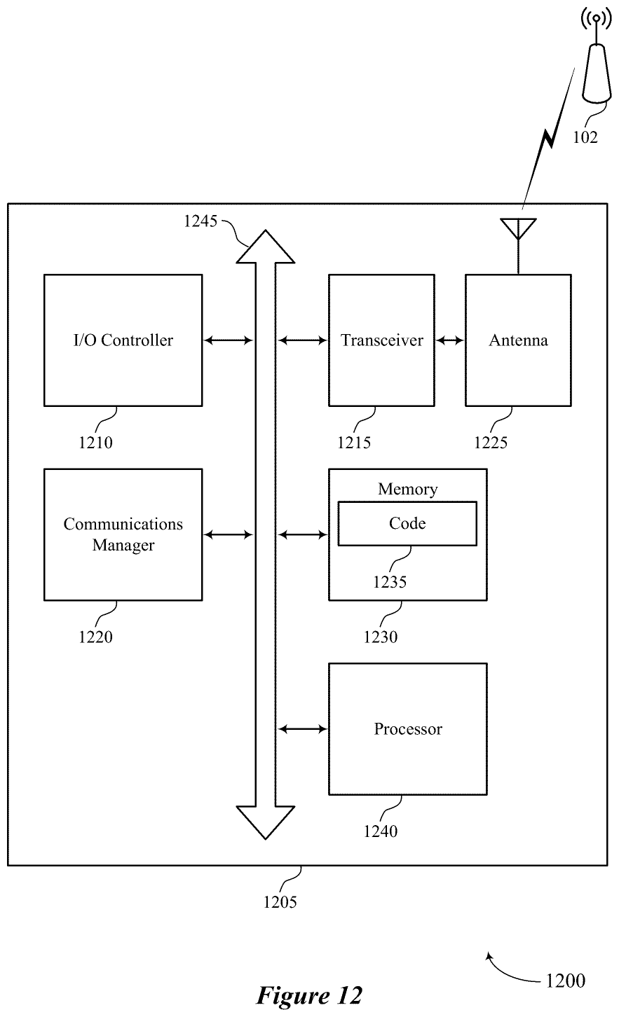

FIG. 12 shows a diagram of a system 1200 including a device 1205 that supports NPCA switching conditions in accordance with one or more aspects of the present disclosure. The device 1205 may be an example of or include components of a device 905, a device 1005, or a STA as described herein. The device 1205 may include components for bi-directional voice and data communications including components for transmitting and receiving communications, such as a communications manager 1220, an I/O controller, such as an I/O controller 1210, a transceiver 1215, one or more antennas 1225, at least one memory 1230, code 1235, and at least one processor 1240. These components may be in electronic communication or otherwise coupled (such as operatively, communicatively, functionally, electronically, electrically) via one or more buses (such as a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. In some other cases, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna. However, in some other cases the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets and provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable, or processor-executable code, such as code 1235. The code 1235 may include instructions that, when executed by the processor 1240, cause the device 1205 to perform various functions described herein. In some cases, the memory 1230 may include, among other things, a BIOS which may control basic hardware or software operation such as the interaction with peripheral components or devices.

The processor 1240 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (such as the memory 1230) to cause the device 1205 to perform various functions (such as functions or tasks supporting NPCA switching conditions). For example, the device 1205 or a component of the device 1205 may include a processor 1240 and memory 1230 coupled to the processor 1240, the processor 1240 and memory 1230 configured to perform various functions described herein.

The communications manager 1220 may support wireless communication in accordance with examples as disclosed herein. For example, the communications manager 1220 is capable of, configured to, or operable to support a means for receiving, from a second wireless communication device and on a first primary channel, an indication of a frame initiating a transmission opportunity associated with an upcoming data transmission on the first primary channel. The communications manager 1220 is capable of, configured to, or operable to support a means for switching to a second primary channel based on determining that a threshold duration has elapsed from an end of the frame initiating the transmission opportunity. The communications manager 1220 is capable of, configured to, or operable to support a means for communicating on the second primary channel based on switching to the second primary channel.

Additionally, or alternatively, the communications manager 1220 may support wireless communication in accordance with examples as disclosed herein. For example, the communications manager 1220 is capable of, configured to, or operable to support a means for receiving, from a second wireless communication device and on a first primary channel, an indication of a PHY PPDU associated with an upcoming data transmission on the first primary channel, the PPDU including a header portion and a data portion. The communications manager 1220 is capable of, configured to, or operable to support a means for switching to a second primary channel based on a length of the PPDU satisfying a threshold value and on the PPDU being an inter-BSS PPDU. The communications manager 1220 is capable of, configured to, or operable to support a means for communicating on the second primary channel based on switching to the second primary channel.

By including or configuring the communications manager 1220 in accordance with examples as described herein, the device 1205 may support techniques for improved communication reliability, reduced latency, improved user experience related to reduced processing, reduced power consumption, more efficient utilization of communication resources, and improved coordination between devices.

FIG. 13 shows a flowchart illustrating an example process 1300 performable by or at an apparatus that supports NPCA switching conditions. The operations of the process 1300 may be implemented by an apparatus or its components as described herein. For example, the process 1300 may be performed by a wireless communication device, such as the wireless communication device 1100 described with reference to FIG. 11, operating as or within a wireless STA. In some examples, the process 1300 may be performed by a wireless STA, such as one of the STAs 104 described with reference to FIG. 1.

In some examples, in 1305, the apparatus may receive, from a second wireless communication device and on a first primary channel, an indication of a frame initiating a transmission opportunity associated with an upcoming data transmission on the first primary channel. The operations of 1305 may be performed in accordance with examples as disclosed herein. In some implementations, aspects of the operations of 1305 may be performed by an indication component 1125 as described with reference to FIG. 11.

In some examples, in 1310, the apparatus may switch to a second primary channel based on determining that a threshold duration has elapsed from an end of the frame initiating the transmission opportunity. The operations of 1310 may be performed in accordance with examples as disclosed herein. In some implementations, aspects of the operations of 1310 may be performed by a channel switching component 1130 as described with reference to FIG. 11.

In some examples, in 1315, the apparatus may communicate on the second primary channel based on switching to the second primary channel. The operations of 1315 may be performed in accordance with examples as disclosed herein. In some implementations, aspects of the operations of 1315 may be performed by a communication component 1135 as described with reference to FIG. 11.

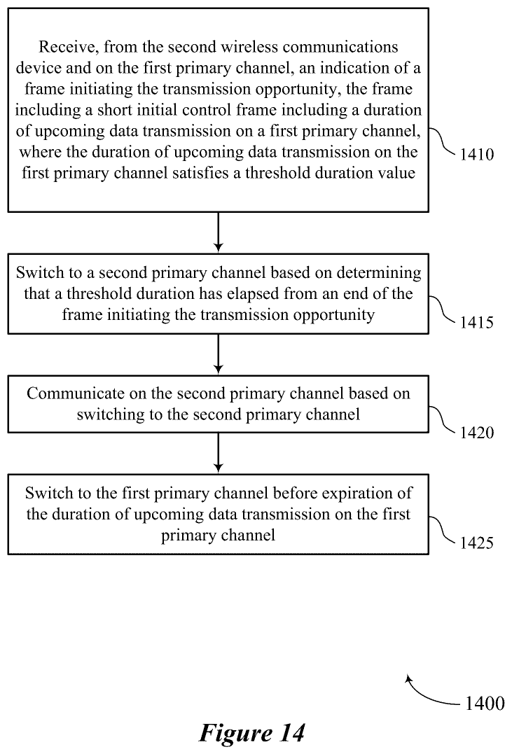

FIG. 14 shows a flowchart illustrating an example process 1400 performable by or at an apparatus that supports NPCA switching conditions. The operations of the process 1400 may be implemented by an apparatus or its components as described herein. For example, the process 1400 may be performed by a wireless communication device, such as the wireless communication device 1100 described with reference to FIG. 11, operating as or within a wireless STA. In some examples, the process 1400 may be performed by a wireless STA, such as one of the STAs 104 described with reference to FIG. 1.

In some examples, in 1410, the apparatus may receive, from the second wireless communication device and on the first primary channel, an indication of a frame initiating the transmission opportunity, the frame including a short initial control frame including a duration of upcoming data transmission on a first primary channel, where the duration of upcoming data transmission on the first primary channel satisfies a threshold duration value. The operations of 1410 may be performed in accordance with examples as disclosed herein. In some implementations, aspects of the operations of 1410 may be performed by an indication component 1125 as described with reference to FIG. 11.

In some examples, in 1415, the apparatus may switch to a second primary channel based on determining that a threshold duration has elapsed from an end of the frame initiating the transmission opportunity. The operations of 1415 may be performed in accordance with examples as disclosed herein. In some implementations, aspects of the operations of 1415 may be performed by a channel switching component 1130 as described with reference to FIG. 11.

In some examples, in 1420, the apparatus may communicate on the second primary channel based on switching to the second primary channel. The operations of 1420 may be performed in accordance with examples as disclosed herein. In some implementations, aspects of the operations of 1420 may be performed by a communication component 1135 as described with reference to FIG. 11.

In some examples, in 1425, the apparatus may switch to the first primary channel before expiration of the duration of upcoming data transmission on the first primary channel. The operations of 1425 may be performed in accordance with examples as disclosed herein. In some implementations, aspects of the operations of 1425 may be performed by a channel switching component 1130 as described with reference to FIG. 11.

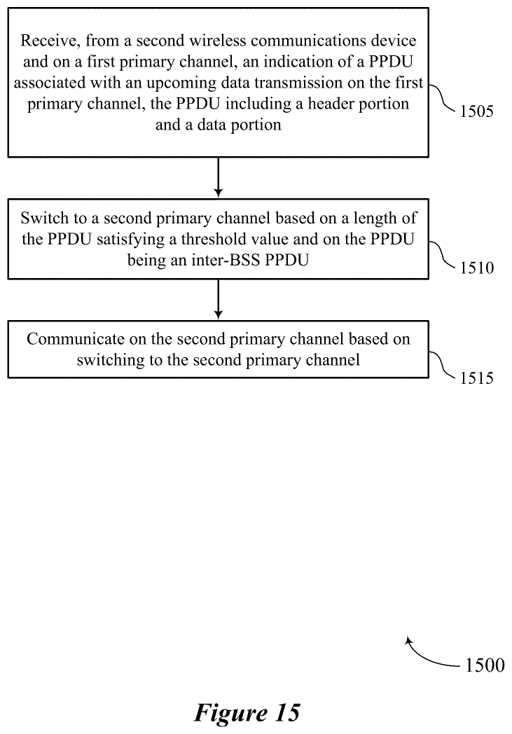

FIG. 15 shows a flowchart illustrating an example process 1500 performable by or at an apparatus that supports NPCA switching conditions. The operations of the process 1500 may be implemented by an apparatus or its components as described herein. For example, the process 1500 may be performed by a wireless communication device, such as the wireless communication device 1100 described with reference to FIG. 11, operating as or within a wireless STA. In some examples, the process 1500 may be performed by a wireless STA, such as one of the STAs 104 described with reference to FIG. 1.

In some examples, in 1505, the apparatus may receive, from a second wireless communication device and on a first primary channel, an indication of a PHY PPDU associated with an upcoming data transmission on the first primary channel, the PPDU including a header portion and a data portion. The operations of 1505 may be performed in accordance with examples as disclosed herein. In some implementations, aspects of the operations of 1505 may be performed by an indication component 1125 as described with reference to FIG. 11.

In some examples, in 1510, the apparatus may switch to a second primary channel based on a length of the PPDU satisfying a threshold value and on the PPDU being an inter-BSS PPDU. The operations of 1510 may be performed in accordance with examples as disclosed herein. In some implementations, aspects of the operations of 1510 may be performed by a channel switching component 1130 as described with reference to FIG. 11.

In some examples, in 1515, the apparatus may communicate on the second primary channel based on switching to the second primary channel. The operations of 1515 may be performed in accordance with examples as disclosed herein. In some implementations, aspects of the operations of 1515 may be performed by a communication component 1135 as described with reference to FIG. 11.

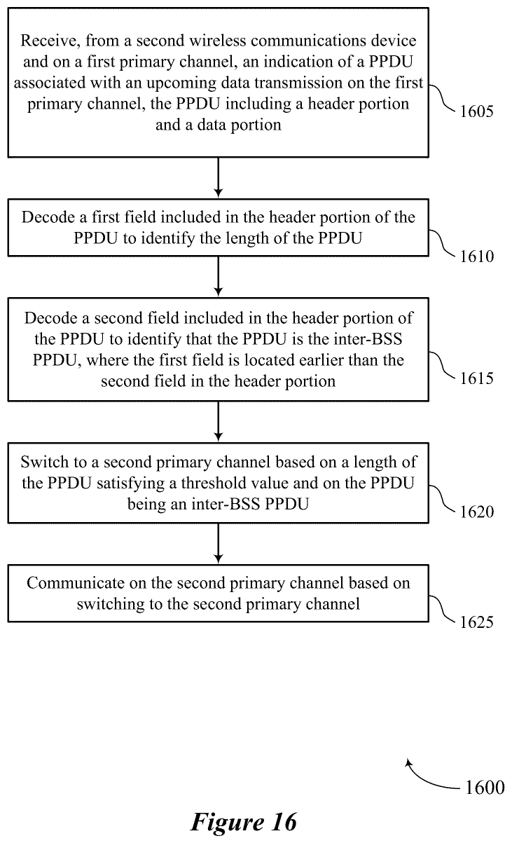

FIG. 16 shows a flowchart illustrating an example process 1600 performable by or at an apparatus that supports NPCA switching conditions. The operations of the process 1600 may be implemented by an apparatus or its components as described herein. For example, the process 1600 may be performed by a wireless communication device, such as the wireless communication device 1100 described with reference to FIG. 11, operating as or within a wireless STA. In some examples, the process 1600 may be performed by a wireless STA, such as one of the STAs 104 described with reference to FIG. 1.

In some examples, in 1605, the apparatus may receive, from a second wireless communication device and on a first primary channel, an indication of a PHY PPDU associated with an upcoming data transmission on the first primary channel, the PPDU including a header portion and a data portion. The operations of 1605 may be performed in accordance with examples as disclosed herein. In some implementations, aspects of the operations of 1605 may be performed by an indication component 1125 as described with reference to FIG. 11.

In some examples, in 1610, the apparatus may decode a first field included in the header portion of the PPDU to identify the length of the PPDU. The operations of 1610 may be performed in accordance with examples as disclosed herein. In some implementations, aspects of the operations of 1610 may be performed by a communication component 1135 as described with reference to FIG. 11.

In some examples, in 1615, the apparatus may decode a second field included in the header portion of the PPDU to identify that the PPDU is the inter-BSS PPDU, where the first field is located earlier than the second field in the header portion. The operations of 1615 may be performed in accordance with examples as disclosed herein. In some implementations, aspects of the operations of 1615 may be performed by a communication component 1135 as described with reference to FIG. 11.

In some examples, in 1620, the apparatus may switch to a second primary channel based on a length of the PPDU satisfying a threshold value and on the PPDU being an inter-BSS PPDU. The operations of 1620 may be performed in accordance with examples as disclosed herein. In some implementations, aspects of the operations of 1620 may be performed by a channel switching component 1130 as described with reference to FIG. 11.

In some examples, in 1625, the apparatus may communicate on the second primary channel based on switching to the second primary channel. The operations of 1625 may be performed in accordance with examples as disclosed herein. In some implementations, aspects of the operations of 1625 may be performed by a communication component 1135 as described with reference to FIG. 11.

Implementation examples are described in the following numbered clauses:

The following provides an overview of aspects of the present disclosure:

Aspect 1: A method for wireless communication by a first wireless communications device comprising: receiving, from a second wireless communications device and on a first primary channel, an indication of a frame initiating a transmission opportunity associated with an upcoming data transmission on the first primary channel; switching to a second primary channel based at least in part on determining that a threshold duration has elapsed from an end of the frame initiating the transmission opportunity; and communicating on the second primary channel based at least in part on switching to the second primary channel.

Aspect 2: The method of aspect 1, wherein receiving the indication further comprises: receiving, from the second wireless communications device and on the first primary channel, the indication of a short initial control frame comprising a duration of upcoming data transmission on the first primary channel, wherein the duration of upcoming data transmission on the first primary channel satisfies a threshold duration value.

Aspect 3: The method of aspect 2, further comprising: switching to the first primary channel before expiration of the duration of upcoming data transmission on the first primary channel.

Aspect 4: The method of any of aspects 2 through 3, wherein the threshold duration comprises a sum of an initial control frame time value, a receiver start delay time value, and two times a short interframe space time value.

Aspect 5: The method of any of aspects 2 through 4, wherein the indication of the short initial control frame is included in an initial control frame list, the initial control frame list comprises one or more of a request to send frame, a multi-user request to send frame, a trigger frame, a block acknowledgement request frame, or any combination thereof.

Aspect 6: The method of any of aspects 2 through 5, further comprising: initiating a first timer and a second timer upon receiving the indication of a short initial control frame, wherein a value of the first timer comprises a sum of a short interframe space time value, a slot time value and a receiver start delay time value, and a value of the second timer comprises a sum of two times the short interframe space time value, a maximum initial control frame time value and the receiver start delay time value, and wherein switching to the second primary channel is based at least in part on the first timer, on the second timer, or both.

Aspect 7: The method of aspect 6, further comprising: receiving, from the second wireless communications device and on the first primary channel, a physical layer reception start indication after expiry of the first timer and before expiry of the second timer, wherein switching to the second primary channel comprises switching to the second primary channel before the expiry of the second timer based at least in part on receiving the physical layer reception start indication.

Aspect 8: The method of any of aspects 1 through 7, wherein receiving the indication further comprises: receiving, from the second wireless communications device and on the first primary channel, the indication of a short initial control response comprising a duration of upcoming data transmission on the first primary channel, wherein the duration of upcoming data transmission on the first primary channel satisfies a threshold duration value.

Aspect 9: The method of aspect 8, wherein the threshold duration comprises a sum of a receiver start delay time value and a short interframe space time value.

Aspect 10: The method of any of aspects 8 through 9, wherein the indication of the short initial control response is included in an initial control response list, the initial control response list comprises one or more of a clear to send frame, a quality of service indication, a block acknowledgement, or any combination thereof.

Aspect 11: The method of any of aspects 1 through 10, further comprising: receiving an indication of a threshold duration value for a duration of upcoming data transmission on the first primary channel, wherein the indication comprises a duration field of a medium access control (MAC) header, a transmission opportunity field of a physical preamble, or both.

Aspect 12: The method of any of aspects 1 through 11, wherein a frame length of the frame initiating the transmission opportunity satisfies a threshold length, the threshold length is predefined or indicated to the first wireless communications device.

Aspect 13: The method of any of aspects 1 through 12, wherein the upcoming data transmission is transmitted as a plurality of PPDUs, and at least one PPDU of the plurality of PPDUs fails to satisfy a PPDU length threshold.

Aspect 14: The method of any of aspects 1 through 13, wherein the first

primary channel comprises a main primary channel, and the second primary channel comprises an opportunistic primary channel.

Aspect 15: The method of any of aspects 1 through 14, wherein the first wireless communications device comprises a NPCA capable station.

Aspect 16: A method for wireless communication by a first wireless communications device comprising: receiving, from a second wireless communications device and on a first primary channel, an indication of a PPDU associated with an upcoming data transmission on the first primary channel, the PPDU comprising a header portion and a data portion; switching to a second primary channel based at least in part on a length of the PPDU satisfying a threshold value and on the PPDU being an inter-BSS PPDU; and communicating on the second primary channel based at least in part on switching to the second primary channel.

Aspect 17: The method of aspect 16, further comprising: decoding a first field included in the header portion of the PPDU to identify the length of the PPDU; and decoding a second field included in the header portion of the PPDU to identify that the PPDU is the inter-BSS PPDU, wherein the first field is located earlier than the second field in the header portion.

Aspect 18: The method of aspect 17, wherein switching to the second

primary channel further comprises: switching to the second primary channel in response to decoding the second field included in the header portion of the PPDU to identify that the PPDU is the inter-BSS PPDU.

Aspect 19: The method of any of aspects 17 through 18, wherein switching to the second primary channel further comprises: switching to the second primary channel based at least in part on determining that a processing delay duration has elapsed after decoding the second field included in the header portion of the PPDU to identify that the PPDU is the inter-BSS PPDU.

Aspect 20: The method of any of aspects 17 through 19, wherein switching to the second primary channel further comprises: switching to the second primary channel based at least in part on determining that an offset duration has elapsed after decoding the first field included in the header portion of the PPDU to identify the length of the PPDU.

Aspect 21: The method of any of aspects 16 through 20, further comprising: receiving, from a third wireless communications device, an indication of one or more of the threshold value, a processing delay duration, an offset duration, or any combination thereof.

Aspect 22: The method of any of aspects 16 through 21, further comprising: receiving, from the second wireless communications device and on the first primary channel, an indication of a frame initiating a transmission opportunity associated with an upcoming data transmission on the first primary channel, the frame comprising a duration of upcoming data transmission on the first primary channel; and refraining from switching to the second primary channel in response to receiving the frame based at least in part on the duration of upcoming data transmission on the first primary channel not satisfying a threshold duration value.

Aspect 23: The method of aspect 22, wherein the frame comprises a short initial control frame, or a short initial control response, or both.

Aspect 24: The method of any of aspects 16 through 23, wherein the first primary channel comprises a main primary channel, and the second primary channel comprises an opportunistic primary channel.

Aspect 25: The method of any of aspects 16 through 24, wherein the first wireless communications device comprises a NPCA capable station.

Aspect 26: An apparatus for wireless communication, comprising one or more memories storing processor-executable code, and one or more processors coupled with the one or more memories and individually or collectively operable to execute the code to cause the apparatus to perform a method of any of aspects 1 through 15.

Aspect 27: An apparatus for wireless communication, comprising at least one means for performing a method of any of aspects 1 through 15.

Aspect 28: A non-transitory computer-readable medium storing code for wireless communication, the code comprising instructions executable by one or more processors to perform a method of any of aspects 1 through 15.

Aspect 29: An apparatus for wireless communication, comprising one or more memories storing processor-executable code, and one or more processors coupled with the one or more memories and individually or collectively operable to execute the code to cause the apparatus to perform a method of any of aspects 16 through 25.

Aspect 30: An apparatus for wireless communication, comprising at least one means for performing a method of any of aspects 16 through 25.

Aspect 31: A non-transitory computer-readable medium storing code for wireless communication, the code comprising instructions executable by one or more processors to perform a method of any of aspects 16 through 25.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus, comprising:
a processing system that includes processor circuitry and memory circuitry that stores code, the processing system configured to cause the apparatus to:
receive, from a second wireless communication device and on a first primary channel, an indication of a frame initiating a transmission opportunity associated with an upcoming data transmission on the first primary channel;
switch to a second primary channel based at least in part on determining that a threshold duration has elapsed from an end of the frame initiating the transmission opportunity; and
communicate on the second primary channel based at least in part on switching to the second primary channel.

2. The apparatus of claim 1, wherein, to receive the indication, the processing system is further configured to cause the apparatus to:
receive, from the second wireless communication device and on the first primary channel, the indication of a short initial control frame comprising a duration of the upcoming data transmission on the first primary channel, wherein the duration of the upcoming data transmission on the first primary channel satisfies a threshold duration value.

3. The apparatus of claim 2, wherein the processing system is further configured to cause the apparatus to:
switch to the first primary channel before expiration of the duration of the upcoming data transmission on the first primary channel.

4. The apparatus of claim 2, wherein the threshold duration comprises a sum of an initial control frame time value, a receiver start delay time value, and two times a short interframe space time value.

5. The apparatus of claim 2, wherein:
the indication of the short initial control frame is included in an initial control frame list, and
the initial control frame list comprises one or more of a request to send frame, a multi-user request to send frame, a trigger frame, a block acknowledgement request frame, or any combination thereof.

6. The apparatus of claim 2, wherein the processing system is further configured to cause the apparatus to:
initiate a first timer and a second timer upon receiving the indication of the short initial control frame, wherein a value of the first timer comprises a sum of a short interframe space time value, a slot time value and a receiver start delay time value, and a value of the second timer comprises a sum of two times the short interframe space time value, a maximum initial control frame time value and the receiver start delay time value, and wherein switching to the second primary channel is based at least in part on the first timer, on the second timer, or both.

7. The apparatus of claim 6, wherein the processing system is further configured to cause the apparatus to:
receive, from the second wireless communication device and on the first primary channel, a physical layer reception start indication after expiry of the first timer and before expiry of the second timer, wherein switching to the second primary channel comprises switching to the second primary channel before the expiry of the second timer based at least in part on receiving the physical layer reception start indication.

8. The apparatus of claim 1, wherein, to receive the indication, the processing system is further configured to cause the apparatus to:
receive, from the second wireless communication device and on the first primary channel, the indication of a short initial control response comprising a duration of the upcoming data transmission on the first primary channel, wherein the duration of the upcoming data transmission on the first primary channel satisfies a threshold duration value.

9. The apparatus of claim 8, wherein the threshold duration comprises a sum of a receiver start delay time value and a short interframe space time value.

10. The apparatus of claim 8, wherein:
the indication of the short initial control response is included in an initial control response list, and
the initial control response list comprises one or more of a clear to send frame, a quality of service indication, a block acknowledgement, or any combination thereof.

11. An apparatus, comprising:
a processing system that includes processor circuitry and memory circuitry that stores code, the processing system configured to cause the apparatus to:
receive, from a second wireless communication device and on a first primary channel, an indication of a physical layer protocol data unit (PPDU) associated with an upcoming data transmission on the first primary channel, the PPDU comprising a header portion and a data portion;
switch to a second primary channel based at least in part on a length of the PPDU satisfying a threshold value and on the PPDU being an inter-basic service set (inter-BSS) PPDU; and
communicate on the second primary channel based at least in part on switching to the second primary channel.

12. The apparatus of claim 11, wherein the processing system is further configured to cause the apparatus to:
decode a first field included in the header portion of the PPDU to identify the length of the PPDU; and
decode a second field included in the header portion of the PPDU to identify that the PPDU is the inter-BSS PPDU, wherein the first field is located earlier than the second field in the header portion.

13. The apparatus of claim 12, wherein, to switch to the second primary channel, the processing system is further configured to cause the apparatus to:
switch to the second primary channel in response to decoding the second field included in the header portion of the PPDU to identify that the PPDU is the inter-BSS PPDU.

14. The apparatus of claim 12, wherein, to switch to the second primary channel, the processing system is further configured to cause the apparatus to:
switch to the second primary channel based at least in part on determining that a processing delay duration has elapsed after decoding the second field included in the header portion of the PPDU to identify that the PPDU is the inter-BSS PPDU.

15. The apparatus of claim 12, wherein, to switch to the second primary channel, the processing system is further configured to cause the apparatus to:
switch to the second primary channel based at least in part on determining that an offset duration has elapsed after decoding the first field included in the header portion of the PPDU to identify the length of the PPDU.

16. The apparatus of claim 11, wherein the processing system is further configured to cause the apparatus to:
receive, from a third wireless communication device, an indication of one or more of the threshold value, a processing delay duration, an offset duration, or any combination thereof.

17. The apparatus of claim 11, wherein the processing system is further configured to cause the apparatus to:
receive, from the second wireless communication device and on the first primary channel, an indication of a frame initiating a transmission opportunity associated with the upcoming data transmission on the first primary channel, the frame comprising a duration of the upcoming data transmission on the first primary channel; and
refrain from switching to the second primary channel in response to receiving the frame based at least in part on the duration of the upcoming data transmission on the first primary channel not satisfying a threshold duration value.

18. A method for wireless communication by a first wireless communication device comprising:
receiving, from a second wireless communication device and on a first primary channel, an indication of a frame initiating a transmission opportunity associated with an upcoming data transmission on the first primary channel;
switching to a second primary channel based at least in part on determining that a threshold duration has elapsed from an end of the frame initiating the transmission opportunity; and
communicating on the second primary channel based at least in part on switching to the second primary channel.

19. The method of claim 18, wherein receiving the indication further comprises:
receiving, from the second wireless communication device and on the first primary channel, the indication of a short initial control frame comprising a duration of the upcoming data transmission on the first primary channel, wherein the duration of the upcoming data transmission on the first primary channel satisfies a threshold duration value.

20. The method of claim 18, wherein receiving the indication further comprises:
receiving, from the second wireless communication device and on the first primary channel, the indication of a short initial control response comprising a duration of the upcoming data transmission on the first primary channel, wherein the duration of the upcoming data transmission on the first primary channel satisfies a threshold duration value.
